(19) United States
(12) Patent Application Publication
(10) Pub. No.: US 2024/0207027 A1
(43) Pub. Date: Jun. 27, 2024

(54) ORAL CARE DEVICE

(71) Applicant: TARO PHARMACEUTICAL INDUSTRIES, LTD., Haifa Bay (IL)

(72) Inventor: Yaron Cina, Moshave Sharona (IL)

(21) Appl. No.: 18/555,110

(22) PCT Filed: Apr. 12, 2022
(86) PCT No.: PCT/IB2022/053447

§ 371 Date: Oct. 12, 2023

Related U.S. Application Data
(60) Provisional application No. 63/174,207, filed on Apr. 13, 2021.
(60) Provisional application No. 63/320,890, filed on Mar. 17, 2022.

(51) Int. Cl. A61C 17/02; A46B 11/06; A61C 17/12

(52) U.S. Cl. CPC A61C 17/0208; A46B 11/063; A61C 17/12

(57) ABSTRACT

The present disclosure provides an oral care device including a hollow shaft (120, 920, 1320), a sleeve (110, 910, 1310), and a cleaning portion (115). The hollow shaft can include a first end having a first suction aperture (140, 940, 1340), and a second end having a second suction aperture (125, 925). The hollow shaft can be configured for insertion into a hand grip. The sleeve can surround the hollow shaft of the oral care device, and can be configured to slide along a longitudinal axis and conceal at least a portion of the first suction aperture or the second suction aperture. The sleeve can conceal the first suction aperture or the second suction aperture to easily adjust an amount of suction provided to an oral cavity of a patient. The cleaning portion can be coupled to a portion of the sleeve at the first end of the hollow shaft.

### CROSS-REFERENCE TO RELATED APPLICATIONS

The present application claims the benefit of and priority to U.S. Provisional Patent Application Ser. No. 63/174,207, filed on Apr. 13, 2021, and U.S. Provisional Patent Application Ser. No. 63/320,890, filed on Mar. 17, 2022, the entire contents of which are incorporated herein by reference in their entireties for all purposes.

### BACKGROUND

Proper oral hygiene is necessary to prevent bacterial infection and other diseases of the mouth. However, oral hygiene can be difficult to administer to people with impaired manual abilities (and need assistance in oral care treatment) or to patients that are unconscious, anesthetized, or immobile, such as patients in intensive care units or patients undergoing ventilation. Conventional oral care devices often cannot provide a satisfactory degree of oral care to these patients.

### SUMMARY

Therefore, there is a need for an oral care device that can provide sufficient oral care for a ventilated, anesthetized, or otherwise immobile patient, or for a patient with impaired manual abilities, without causing damage to the patient's mouth. According to one aspect of the present disclosure, provided is an oral care device that is easy for an oral care facilitator to use, and that allows for easy adjustment of the amount of suction of a cleaning agent provided to the oral cavity of a patient. The oral care device can be a single use safe answer to the need for applying mouthwash to the oral region.

At least one aspect of the present disclosure is directed to an oral care device. The oral care device can include a hollow shaft. The hollow shaft can include a first end having a first suction aperture. The hollow shaft can include a second end having a second suction aperture. The second end of the hollow shaft can be configured for insertion into a hand grip. The oral care device can include a sleeve surrounding a portion of the hollow shaft. The sleeve can be configured to slide along a longitudinal axis and configured to conceal one of the first suction aperture or the second suction aperture. By sliding the sleeve, the suction flow of the apertures can be controlled. The oral care device can include a cleaning portion. The cleaning portion can be coupled to a portion of the sleeve proximate to the first end of the hollow shaft.

In some implementations, the oral care device can include a liquid container in fluid communication with the hollow shaft. In some implementations, the liquid container can be disposed within the hand grip that receives the second end of the hollow shaft. In some implementations, the hand grip can include a channel fluidly coupling the liquid container to the hollow shaft. In some implementations, the hollow shaft can include a first stop at the first end of the hollow shaft and a second stop at the second end of the hollow shaft. In some implementations, the first stop and the second stop can prevent the sleeve from sliding beyond the first end and the second end, respectively. In some implementations, the oral care device can include the hand grip. In some implementations, the hand grip further can include a fitting configured to attach to a suction pipe.

In some implementations, the sleeve can include an attachment portion. In some implementations, the cleaning portion can be coupled to and detachable from the sleeve via the attachment portion. In some implementations, the cleaning portion can include a brush head comprising a plurality of bristles extending outward. In some implementations, the brush head can include one or more foam portions positioned adjacent to the plurality of bristles. In some implementations, the cleaning portion can couple to an external swab. In some implementations, the cleaning portion can be semipermeable, and can allow selective passage of liquids through the cleaning portion and into the first suction aperture. In some implementations, the cleaning portion can include a brush head configured to receive a spreading head. In some implementations, the sleeve is rotatable about the longitudinal axis.

In some implementations, the sleeve can be rotated about the longitudinal axis by a user's thumb and/or finger. In some implementations, the oral care device can include a container proximate the second end and comprising liquid. In some implementations, the container can direct liquid toward the first end when force is exerted on the container. In some implementations, the oral care device can include a passage configured to receive the liquid from the container and direct the liquid to the cleaning portion.

At least one other aspect of the present disclosure is directed to a brush head. The brush head can include a receiving cavity defined by one or more walls. The receiving cavity can be configured to receive a cleaning end of an oral care device. The brush head can include a first end of the one or more walls. The first end can include a plurality of bristles projecting outward from a central axis of the brush head. The brush head can include a central portion having a liquid channel and a perforation. The perforation can project outward from the central axis of the brush head.

In some implementations, the brush head can include a liquid reservoir coupled to the central portion of the brush head. In some implementations, the liquid reservoir can include two sections connected by a hinge. In some implementations, the liquid reservoir can be mounted on the brush head such that the liquid reservoir surrounds the central portion and is punctured by the perforation. In some implementations, the liquid reservoir can include a connector configured to couple the two sections of the liquid reservoir with one another responsive to the liquid reservoir being mounted to the central portion of the brush head. In some implementations, the liquid reservoir can be surrounded by a foam layer. In some implementations, the liquid channel of the central portion can be configured to transmit fluid to a base of one or more of the plurality of bristles. In some implementations, the receiving cavity can include a snap-fit connector configured to couple to the cleaning end of the oral care device.

At least one other aspect of the present disclosure is directed to a container for a swab. The container can include one or more walls defining an opening of the container. The container can include a solution disposed within the container. The container can include an oral swab positioned at least partly in the solution such that an opening of the oral swab may be exposed via the opening of the container. The opening of the oral swab can be configured to receive a cleaning portion of an oral care device. The container can include a removable lid that seals the opening of the container.

In some implementations, the oral swab can include a snap-fit connector configured to couple the oral swab to the cleaning portion of the oral care device. In some implementations, the oral swab can be removable from the container responsive to coupling to the cleaning portion of the oral care device.

At least one other aspect of the present disclosure is directed to an assembly for preparing a swab. The assembly can include a canister comprising one or more walls defining an opening of the canister. The assembly can include an oral swab positioned in the canister such that an opening of the oral swab may be exposed via the opening of the canister. The opening of the oral swab can be configured to receive a cleaning portion of an oral care device. The assembly can include a removable lid that seals the opening of the canister. The assembly can include a packet configured to be placed proximate the opening of the canister when the lid is removed. The packet can include a liquid. The packet can be configured to release the liquid into the oral swab when force is applied to the packet.

In some implementations, the packet comprises a sachet. In some implementations, the packet comprises a sachet with a weakened portion configured to release the liquid when force is applied to the sachet. In some implementations, the packet comprises a sachet with a peel-off portion. In some implementations, the packet can include a container with a portion that can be punctured.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form.

### BRIEF DESCRIPTION OF THE DRAWINGS

Like reference numbers and designations in the various drawings indicate like elements. For purposes of clarity, not every component may be labeled in every drawing. The foregoing and other objects, aspects, features, and advantages of the disclosure will become more apparent and better understood by referring to the following description taken in conjunction with the accompanying drawings, in which:

FIGS. 1A and 1B each illustrate perspective views of an example oral care device having a sleeve portion, in accordance with one or more implementations;

FIG. 1C illustrates a frontal view of the example oral care device depicted in FIGS. 1A and 1B, in accordance with one or more implementations;

FIGS. 2A and 2B each illustrate cross-sectional views of an example oral care device having a sleeve portion, in accordance with one or more implementations;

FIGS. 3A, 3B, 3C, and 3D each illustrate perspective views of an example oral care device extracting a swab from an example oral swab container, in accordance with one or more implementations;

FIG. 4 illustrates a cross-sectional view of the example oral care device extracting the swab from the example oral swab container as depicted in FIGS. 3A, 3B, 3C and 3D, in accordance with one or more implementations;

FIG. 5A illustrates a perspective view of an example fluid reservoir having an outer layer, in accordance with one or more implementations;

FIG. 5B illustrates a perspective view of an example brush head having a perforator and fluid channels, in accordance with one or more implementations;

FIGS. 5C and 5D each illustrate perspective views of the example fluid reservoir shown in FIG. 5A being coupled to the example brush head shown in FIG. 5B, in accordance with one or more implementations;

FIGS. 6A and 6B each illustrate perspective views of a sachet container of fluid that can be used with the oral care device described herein, in accordance with one or more implementations;

FIGS. 6C and 6D each illustrate perspective views of the sachet container of FIGS. 6A and 6B being inserted into an exterior sleeve, in accordance with one or more implementations;

FIGS. 6E and 6F each illustrate perspective views of the exterior sleeve of FIGS. 6C and 6D being inserted into an oral swab, in accordance with one or more implementations;

FIG. 6G illustrates a perspective view of the oral care device of FIGS. 1A and 1B being inserted into the exterior sleeve coupled to the oral swab of FIGS. 6E and 6F, in accordance with one or more implementations;

FIG. 6H illustrates a cross-sectional view of the oral care device of FIGS. 1A and 1B being inserted into the exterior sleeve coupled to the oral swab of FIGS. 6E and 6F, in accordance with one or more implementations;

FIGS. 7A, 7B, 7C, and 7D illustrate various views of an example oral swab container with a separate fluid container, in accordance with one or more implementations;

FIG. 8 illustrates a cross-sectional view of a modular grip for an example oral care device shown in FIG. 9, in accordance with one or more implementations;

FIG. 9 illustrates a side view of another example oral care device having a sleeve portion, in accordance with one or more implementations;

FIG. 10 illustrates a perspective view of yet another alternative oral swab container with yet another alternative separate fluid container, in accordance with one or more implementations;

FIG. 11 illustrates an example process of utilizing the example oral care device shown in FIG. 9 with the oral swab container and fluid container shown in FIG. 10, in accordance with one or more implementations;

FIGS. 12A and 12B show side views of the example oral care device shown in FIG. 9, with the sleeve portion in different positions, in accordance with one or more implementations;

FIG. 13A illustrates a cross-sectional view of an example oral care device with an integrated fluid reservoir, in accordance with one or more implementations;

FIGS. 13B, 13C, and 13D illustrate example views of a modular implementation of the example oral care device shown in FIG. 13A, in accordance with one or more implementations;

FIGS. 14A and 14B illustrate side views of the example oral care devices shown in FIGS. 13A-13D, with the sleeve portion in different positions, in accordance with one or more implementations;

FIGS. 14C and 14D illustrate cross-sectional side views of the example oral care devices shown in FIGS. 14A and 14B, in accordance with one or more implementations;

FIGS. 15A and 15B illustrate an example sachet container and oral swab container with a base portion, in accordance with one or more implementations;

FIG. 16 illustrates an example process of utilizing the example sachet container and oral swab container depicted in FIGS. 15A and 15B with the example oral care device shown in FIG. 9, in accordance with one or more implementations;

FIGS. 17A, 17B, and 17C illustrate cross-sectional side views of an oral care device with an integrated fluid reservoir and various dispenser mechanisms, in accordance with one or more implementations;

FIGS. 17D and 17E illustrate various views of housings that may be used in connection with the oral care devices described herein to dispense fluid, in accordance with one or more implementations;

FIG. 17F illustrates a perspective view of an example reservoir that may be utilized in connection with the fluid dispenser mechanisms described herein, in accordance with one or more implementations;

FIGS. 18A, 18B, and 18C illustrate various views of the example sachet container shown in FIGS. 15A and 15B, in accordance with one or more implementations;

FIGS. 19A and 19B illustrate additional perspective views of the example sachet container shown in FIGS. 18A and 18B, in accordance with one or more implementations;

FIGS. 20A and 20B illustrate perspective views of the example sachet container and oral swab container with the base portion shown in FIG. 15B, in accordance with one or more implementations;

FIGS. 21A and 21B illustrate additional perspective views of the example sachet container shown in FIGS. 18A, 18B, 18C, 19A, and 19B, in accordance with one or more implementations;

FIGS. 22A and 22B illustrate perspective views of the example oral swab container with the base portion shown in FIG. 15B, in accordance with one or more implementations; and

FIG. 23 illustrates a side view of an example Yankauer attachment that is usable with the various oral care devices described herein, in accordance with one or more implementations.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

Maintaining proper oral hygiene in incapacitated patients, such as anesthetized, intubated, or comatose patients, is of paramount importance. Without proper oral hygiene, oral infections or other diseases of the mouth can occur. In general, incapacitated patients are treated using an oral care protocol, which can include saliva and mucus removal by suction, plaque and biofilm removal through brushing, debris removal by suction, application of oral disinfectant, and finally suction of excess liquids from the mouth. Thus, it would be advantageous for an oral care device to effectuate each step of an oral care procedure. The oral care device described herein provides such functionality, reduces the risks of cross-patient contamination, and removes the need to use and sterilize (or dispose of) multiple oral care instruments for a single oral care procedure. Further, the oral care device described herein can be coupled with brush heads having integrated liquid reservoirs, which can include cleaning solutions, disinfectant solutions, or other solutions to aid in the provision of oral care.

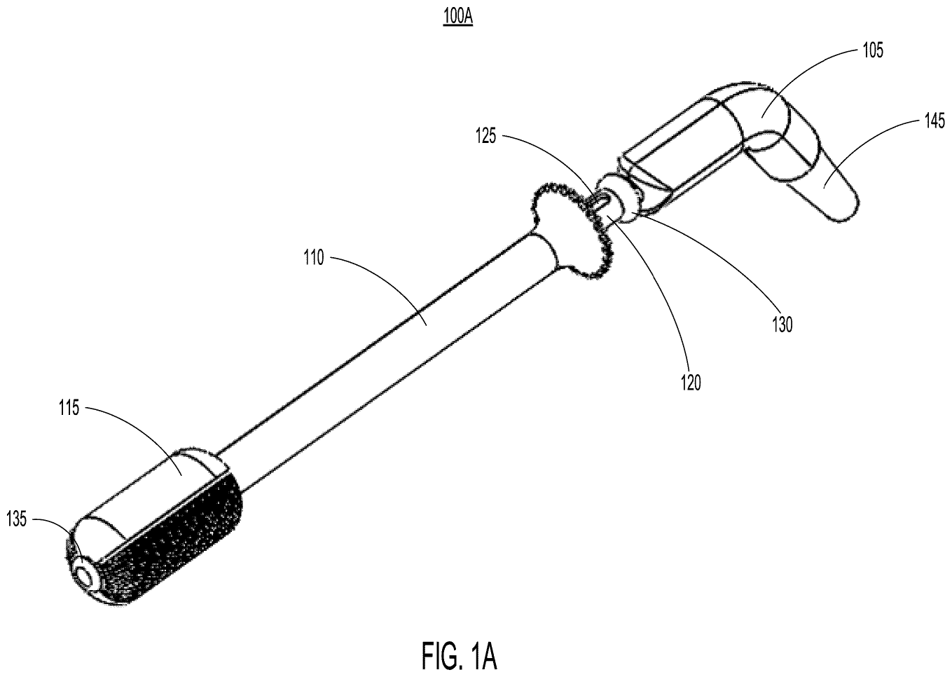

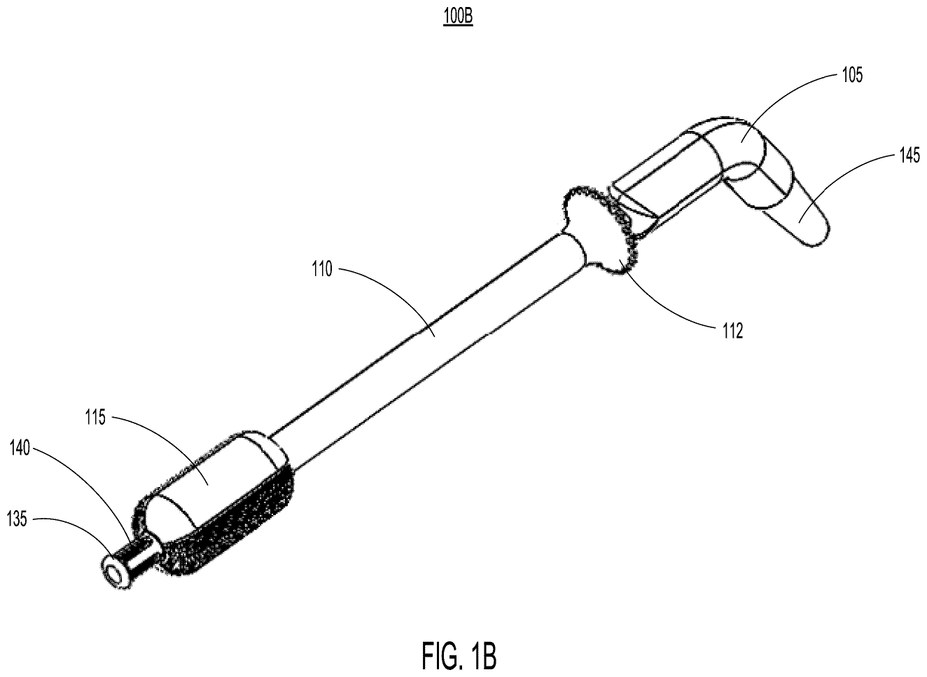

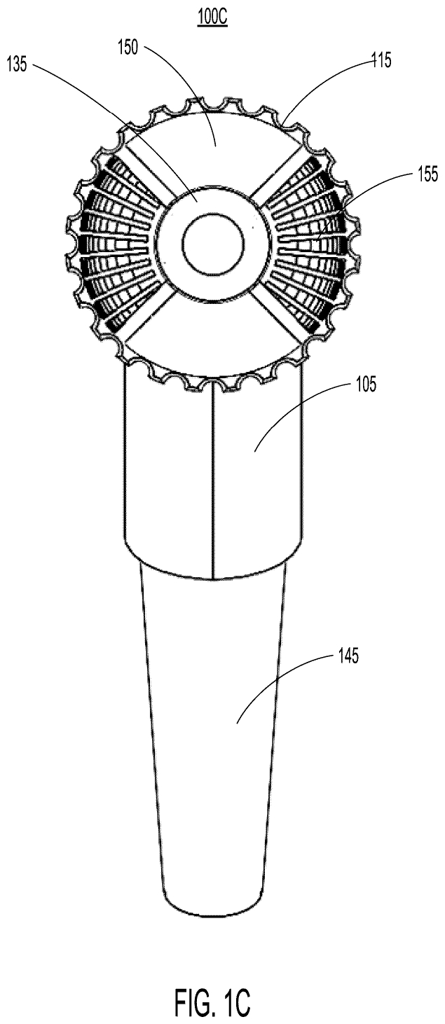

Referring now to FIG. 1A, illustrated is a perspective view 100A of an example oral care device having a sleeve portion 110, which can surround a hollow shaft 120. As shown in the view 100A, the oral care device can include a hand grip 105, the hollow shaft 120, and the sleeve 110 surrounding the hollow shaft 120. The sleeve 110 can include a cleaning portion 115, which can be, for example, a brush head. The hollow shaft 120 can include a first stop 130 and a second stop 135, which can prevent the sleeve 110 from sliding beyond the ends of the hollow shaft 120. To provide suction functionality, the hand grip 105 can include a suction pipe fitting 145, which can be coupled to a suction pipe that provides negative pressure (suction) from a negative pressure source, such as a pump. In addition, the hollow shaft 120 can include suction apertures 125, which can be openings in the hollow shaft 120.

The hand grip 105 can be held by a healthcare provider, or can be coupled to a robotic device that provides oral hygiene procedures to patients. The hand grip 105 can have one or more ergonomic features, making the hand grip 105 comfortable to hold for extended periods of time. The ergonomic features can include a rubber portion or a knurled surface. The hand grip 105 can be coupled to one end of the hollow shaft 120. For example, the hand grip 105 can include an opening into which the hollow shaft 120 is inserted. The inserted end of the hollow shaft 120 can include one or more attachment features, such as a snap-fit connector, a friction fit connector, a press-fit connector, a Luer lock connector, a threaded connector, or another type of connector. The connection between the hollow shaft 120 and the hand grip 105 can be water-tight, and may include one or more O-rings or gaskets between the hollow shaft 120 and the hand grip 105. In some implementations, the hollow shaft 120 and the hand grip 105 can be formed from the same piece of material (e.g., one solid piece with no connecting parts, etc.). The hand grip 105 can be formed from any kind of rigid or semi-flexible material, such as plastic, thermoplastic, metal, ceramic, or a composite material.

The hand grip 105 can itself be hollow, and can be in fluid communication with the hollow shaft 120. The hollow shaft 120 can be manufactured from any kind of rigid or semi-flexible material, such as plastic, thermoplastic, metal, ceramic, or a composite material. The hollow shaft 120 can be coupled to the hand grip 105, and can extend outward from the hand grip 105 along a longitudinal axis. The hollow shaft 120 can be substantially linear. However, in some implementations, the hollow shaft 120 can include one or more bends or bendable portions. In some implementations, the hollow shaft 120 can rotate about the longitudinal axis. By rotating about the longitudinal axis, the cleaning portion 115 can be rotated to apply different surfaces of the cleaning portion 115 to the oral cavity of the patient. For example, rotating the hollow shaft can allow a healthcare provider to apply a foam surface of the cleaning portion 115 to desired locations in the patient's oral cavity, and allow a surface of the cleaning portion 115 having bristles to be applied to another surface of the patient's oral cavity. In some implementations, the hollow shaft 120 can be fixed, and the sleeve 110 can rotate about the longitudinal axis. The hollow shaft 120 can be cylindrical. The hollow shaft 120 can include the first set of suction apertures 125 at the end of the hollow shaft 120 that is coupled to the hand grip 105. The hollow shaft 120 can be in fluid communication with the hand grip 105, which itself can be in fluid communication with an external suction source via the suction pipe connector 145.

The sleeve 110 can be manufactured from any kind of rigid or semi-flexible material, including plastic, thermoplastic, metal, ceramic, or a composite material. The sleeve 110 can be substantially linear, and surround a portion of the length of the hollow shaft 120. The sleeve can slide along the longitudinal axis of the hollow shaft 120, such that the sleeve 110 can cover the suction apertures 125. The sliding action of the sleeve 110 is shown in FIG. 1B. When the sleeve 110 slides along the hollow shaft 120, the sleeve 110 can conceal the apertures 125. The first end stop 130 and the second end stop 135 can prevent the sleeve 110 from sliding off the hollow shaft 120. One or more of the first end stop 130 or the second end stop 135 can be formed as a raised portion of the hollow shaft 120. In some implementations, one or more of the first end stop 130 or the second end stop 135 can be an additional portion that is coupled to the hollow shaft 120, such as a gasket or an O-ring. In some implementations, the sleeve 110 can rotate about the longitudinal axis of the hollow shaft 120 by applying force to the grip 112 of the sleeve portion 110.

The sleeve 110 can include a cleaning portion 115. The cleaning portion 115 can be, for example, a brush head having one or more bristles that extend outward. In some implementations, the cleaning portion 115 can include one or more foam portions or pads. The cleaning portion 115 can be constructed from a combination of bristles, pads, or other cleaning elements, such as a swab material or a sponge-like material. The cleaning portion 115 can include, or can transport, one or more fluids from the base of the cleaning portion to the surface of the cleaning portion, such as a disinfectant solution, or an oral cleaning solution. The cleaning portion 115 can include a foam material that allows for the absorption of liquids into the cleaning portion 115. Additional suction apertures 140 can be positioned underneath the cleaning portion 115 when the sleeve 110 is positioned against the end stop 135, as shown in FIG. 1A. Thus, the cleaning portion 115 can temporarily store liquids (e.g., absorbed in the foam of the cleaning portion 115, etc.), which can be provided to an oral cavity of a patient through the application of pressure to the cleaning portion 115. A perspective view 100A of the sleeve 110 following a sliding action, such that the sleeve 110 is pressed against the end stop 135, is depicted in FIG. 1A.

Referring now to FIG. 1B, illustrated is a perspective view 100B of the example oral care device shown in FIG. 1A, where the sleeve portion 110 is slid into a second position such that the second set of suction apertures 140, near the end stop 135, are exposed, and the set of suction apertures 125 are concealed. The second set of suction apertures 140 are positioned underneath the cleaning portion 115 when the sleeve 110 is pressed against the end stop 135. The suction apertures 140 and the suction apertures 125 can be openings in the hollow tube 120 and communicate with each other via the hollow tube 120, and can be fluidly connected to the inside of the hand grip 105. As described herein above, the hand grip 105 can include the suction pipe connector 145, which can be connected to an external suction device via suction tubing or another type of pipe. In some implementations, the sleeve 110 can include other sliding features (e.g., rails, guide channels, etc.) that can facilitate the motion of the sleeve 110 along the longitudinal axis of the hollow tube 120. In some implementations, one or more of the sleeve 110 or the hollow tube 120 can include a locking feature (e.g., a snap-fit connector that still allows rotation motion about the longitudinal axis, etc.), that prevents the sleeve 110 from sliding once it has been moved to a desired position. The locking feature can, for example, form a part of the stop 135 or the stop 130 on the hollow shaft 120. In some implementations, friction between the hollow tube 120 and the sleeve 110 can prevent the sleeve 110 from sliding when no longitudinal force is applied to the sleeve 110. A frontal view of the oral care device, showing details of a combination bristle and foam brush head, is depicted in FIG. 1C.

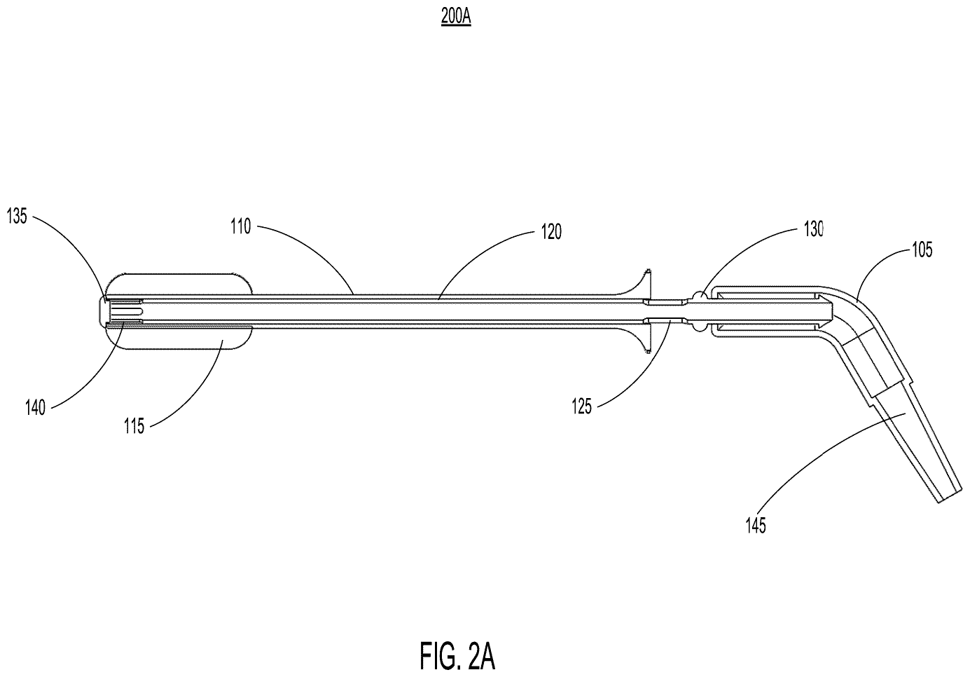

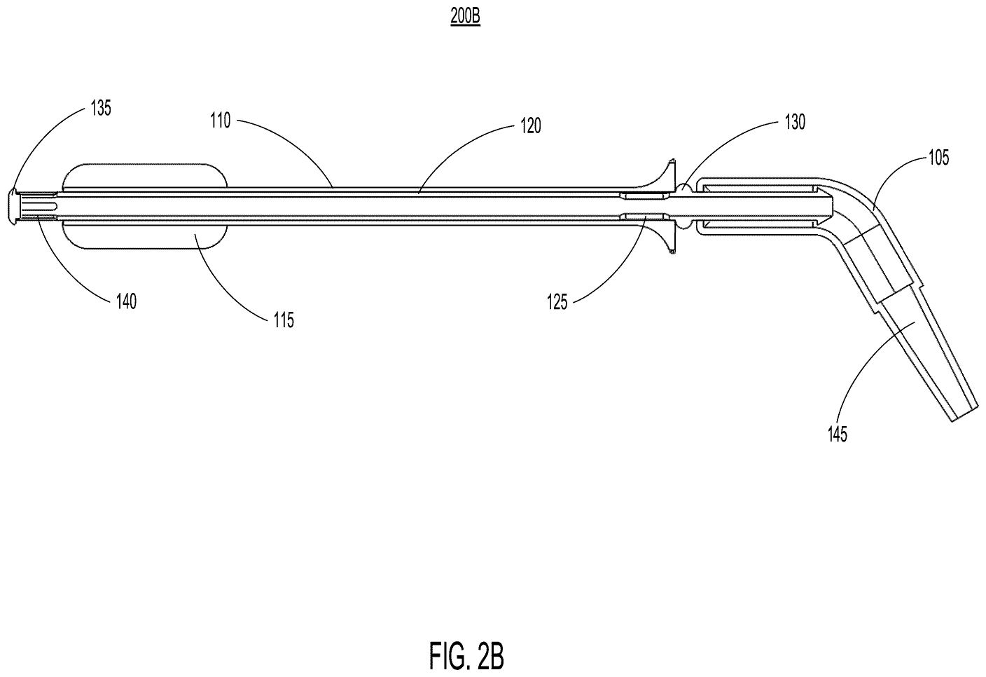

Referring now to FIG. 1C, illustrated is a frontal view 100C of the example oral care device depicted in FIGS. 1A and 1B. As shown in the view 100C, the cleaning portion 115 can be a brush head including one or more foam portions 150 and one or more bristle portions 155. In some implementations, the cleaning portion 115 can be coupled directly to the sleeve 110. However, in some implementations, the cleaning portion 115 can be detachable from the sleeve 110. In some implementations, the sleeve 110 can include a connector for the cleaning portion, such as a snap-fit connector, a friction fit connector, a press-fit connector, a threaded connector, or any other type of mechanical connector that can couple the cleaning portion 115 to the sleeve 110. Although the foam portions 150 of the cleaning portion 115 appear to form about half of the cleaning portion 115 in quarter sections, it should be understood that any portion, and any arrangement, of foam portions 150 and bristle portions 155 are possible to form the cleaning portion 115. As depicted in view 100C, the front-most end of the hollow tube 120 can be closed, such that the center channel of the hollow tube 120 is not exposed. However, in some implementations, the front-most end of the hollow tube 120 can be open. Cross-sectional views 200A and 200B of the center channel of the hollow tube 120, and of the other components of the oral care device, are depicted in FIGS. 2A and 2B.

Referring now to FIG. 2A, illustrated is a cross-sectional view 200A of the example oral care device shown in FIGS. 1A, 1B, and 1C. As depicted in the view 200A, the hollow shaft 120 can include a central channel along the longitudinal axis of the hollow shaft 120. The hollow shaft 120 can include a portion that extends into the hand grip 105, which can itself be hollow. The inside of the hand grip 105 can be in fluid communication with the central channel of the hollow shaft 120. In some implementations, the hollow shaft 120 can be detachable from the hand grip 105, via a connector such as a snap-fit connector, a friction fit connector, a press-fit connector, a threaded connector, or any other type of connector. In some implementations, the connector that connects the hollow shaft 120 to the hand grip 105 can lock the hollow shaft 120 in place such that it may not necessarily rotate with respect to the hand grip 105. However, in some implementations, the connector can allow the hollow tube 120 to rotate about the longitudinal axis of the hollow shaft 120.

In some implementations, a liquid container can be disposed within the hand grip 105, or external to and in fluid communication with the hand grip 105. The liquid container can be, for example, formed as a part of the hand grip 105, and can be refillable via a port present on the surface of the hand grip 105. In some implementations, the liquid container can be external to the hand grip 105, and can be in fluid communication with other components of the oral care device. The hand grip 105 can include one or more channels that fluidly couple the liquid container to the central channel of the hollow shaft 120. The cross-sectional view 200A shows how the sleeve 110 can slide over and conceal the suction apertures 140 near the end stop 135. In some implementations, the sleeve 110 can form a seal over the suction apertures 140 (e.g., a watertight seal, an airtight seal, etc.) using one or more sealing features, such as a gasket or another type of seal.

Further, as the suction pipe connector 145 is in fluid communication with the hand grip 105 and in fluid communication with the hollow tube 120, fluids that pass through the suction apertures 125 or the suction apertures 140 can flow through the hollow tube 120 and the hand grip 105, and out of the oral care device via the suction pipe connector 145. Thus, an external suction device can create a negative pressure in the hand grip 105, and draw undesired fluid and debris from a patient's oral cavity via the suction apertures 140 (or the suction apertures 125). Likewise, using a positive pressure, liquid from a liquid container disposed within (or external to) the hand grip 105 can be provided to the oral cavity of a patient via the hollow tube 120 and the apertures 140 or the apertures 125. Thus, the liquid container can be used to provide chemical cleaning (e.g., oral disinfectants, toothpaste solutions, or other oral cleaning solutions, etc.), in conjunction with the mechanical cleaning provided by the cleaning portion 115. As described herein above, the sleeve 110 can slide along the longitudinal axis of the hollow tube 120. An example view of the oral care device having the sleeve 110 positioned over and concealing the suction apertures 125 is depicted in FIG. 2B.

Referring now to FIG. 2B, illustrated is a cross-sectional view 200B of the example oral care device shown in FIGS. 1A, 1B, and 1C. As shown, the sleeve 110 can slide along the longitudinal axis of the hollow tube 120, causing the sleeve to cover (e.g., conceal), the suction apertures 125 near the end stop 130. In some implementations, the sleeve 110 can form a seal over the suction apertures 125 (e.g., a watertight seal, an airtight seal, etc.) using one or more sealing features, such as a gasket or another type of seal. In some implementations, the sleeve 110 can lock to one of the end stop 130 or the end stop 135, or to a portion of the hollow shaft 120. In some implementations, the sleeve 110 can include a spring feature that causes the sleeve 110 to return from the position depicted in FIG. 2B to the position depicted in FIG. 2A (or vice versa) in the absence of a force being applied to the sleeve 110. For example, a health care provider can draw the sleeve 110 backward (e.g., toward the end stop 130) using a force to expose the apertures 140, and upon releasing the sleeve 110, the sleeve 110 can spring back to the position where the sleeve covers the apertures 140. The spring feature can be coupled to the hollow shaft 120, for example, near the end stop 130 or near the end stop 135. When the suction apertures 140 are exposed, an external suction source can be used to extract mucus, fluid, or other debris from the oral cavity of a patient via the hollow tube 120. By applying longitudinal force to the sleeve 110 and causing the sleeve 110 to slide along the hollow tube 120, the healthcare provider can manually and precisely adjust the size of the apertures 140 uncovered by the sleeve 110, and thus the amount of suction force that is applied by the apertures 140 in the patient's oral cavity. In doing so, the healthcare provider can avoid causing damage to the patient oral cavity due to excess suction in sensitive areas.

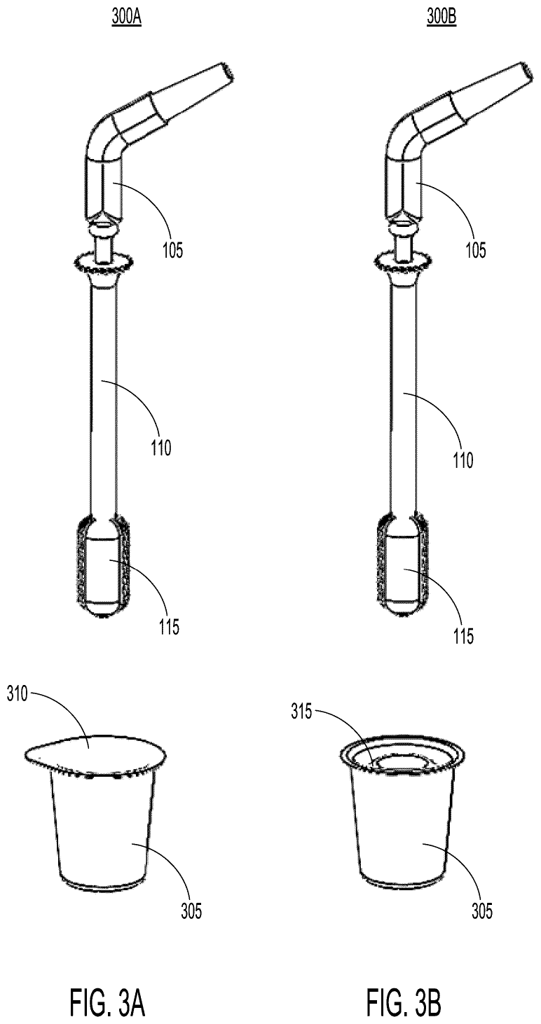

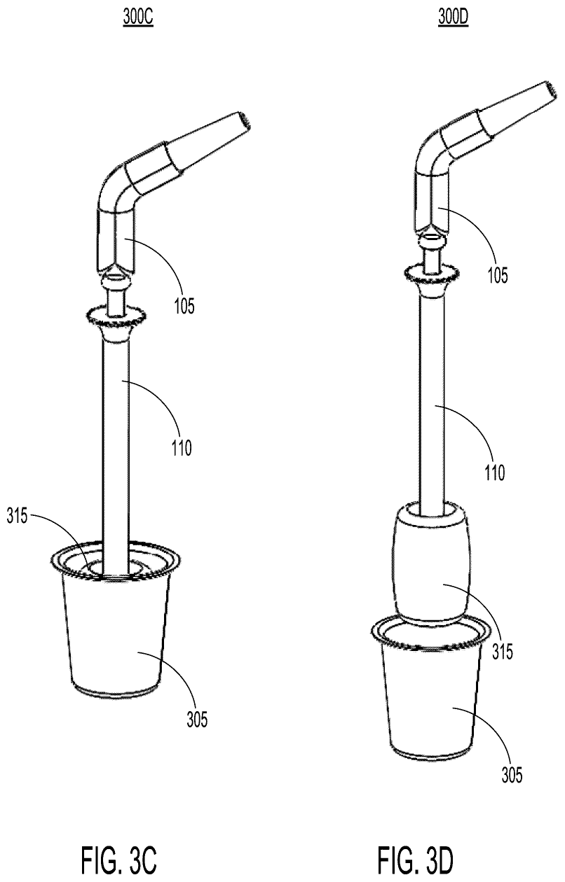

Referring now to FIG. 3A, illustrated is a perspective view 300A of a first stage of an oral swab extraction process flow. As depicted, the oral care device shown in FIGS. 1A, 1B, 1C, 2A, and 2B, can be used to extract an oral swab from an oral swab container 305. The oral swab container can include one or more walls. Although the oral swab container 305 is shown as a substantially cylindrical container having a circular opening covered by a sealing lid 310, it should be understood that the container 305 can be formed into any shape, and have any size or shape opening covered by the sealing lid 310. In some implementations, the container 305 and the sealing lid 310 can be formed from a high-barrier material, which can prevent oxygen, water, light, and other elements from entering or exiting the container 305. The sealing lid 310 can be formed from a flexible high-barrier film, and can be coupled to the body of the container 305 using an adhesive or another type of coupling. The sealing lid 310 can be removable, such that the contents of the container 305 are exposed when the sealing lid 310 is removed from the opening of the container 305. The cleaning end 115 of the oral care device can be used to extract the contents of the container 305 following the removal of the sealing lid 310. In some implementations, the cleaning end 115 of the oral care device can assist removal of the sealing lid 310 of the container 305 to expose the contents of the container 305. A depiction of the sealing lid 310 having been removed from the container 305, exposing the contents of the container 305, is shown in FIG. 3B.

Referring now to FIG. 3B, illustrated is a perspective view 300B of a second stage of an oral swab extraction process flow. As depicted in the view 300B, the oral care device has not yet been used to extract the contents of the container 305. However, the sealing lid 310 of the container 305 has been removed, exposing the contents of the container 305. The container 305 can include a solution. The solution can be, for example, an oral disinfectant, an oral cleaning agent, or any other solution that can be used in an oral hygiene routine. As shown, the container 305 can include an oral swab 315. The oral swab 315 can be, for example, an oral swab that can couple to the cleaning portion 115 of the oral care device. The oral swab 315 can be positioned in the container 305 such that the oral swab 315 is submerged, or partially submerged, in the solution described herein above. The oral swab 315 can, in some implementations, be substantially cylindrical, and can include an opening that receives the cleaning portion 115 of the oral care device. The oral swab 315 can be positioned in the container 305 such that the opening of the oral swab 315 is exposed when the sealing lid 310 is removed from the container 305. The opening of the oral swab 315 can be circular, square, rectangular, or any other shape that can receive the cleaning portion 115 of the oral care device. An illustration of the oral care device being used to extract the oral swab 315 from the container 305 is shown in FIG. 3C. In some implementations, the container 305 may include only a dose of an oral hygiene fluid, and may not include an oral swab 315. Sponges or other absorbent portions of the cleaning portion 115 of the oral care device can be inserted into the container 305 and absorb the oral hygiene fluid directly without the use of an oral swab 315.

Referring now to FIG. 3C, illustrated is a perspective view 300C of a third stage of an oral swab extraction process flow. At this stage in the process, the cleaning portion 115 of the oral care device can be inserted into the opening of the oral swab 315 via the opening of the container 305. The cleaning portion 115 can be inserted, for example, by a health care provider or another user of the oral care device. In some implementations, the opening of the oral swab 315 can form a cavity that accepts the entirety of the cleaning portion 115 of the oral care device. However, in some implementations, the oral swab may accept a portion, or a segment, of the cleaning portion 115. Following insertion, the oral swab 315 can couple to the cleaning portion 115 of the oral care device, such that the oral swab 315 can remain attached to the oral care device when the oral care device is withdrawn from the container 305. In some implementations, the oral swab 315 can include one or more connectors that couple to the cleaning portion 115 of the oral care device. The one or more connectors can include, for example, a snap-fit connector, a press-fit connector, a friction fit connector, a threaded connector, or any other type of mechanical connector. The connector can be a “one-way” connector, such that once coupled, the oral swab 315 and the cleaning portion 115 cannot be disconnected. The one-way connector can “click,” or emit an audible sound, to indicate the cleaning portion 115 has been permanently coupled to the oral swab 315. The oral swab 315 can include an outer portion that can contact the inside of a patient's oral cavity. The outer portion can include, for example, a foam portion, a cotton portion, a brush portion, or a combination thereof. A depiction of the oral swab 315 being withdrawn from the container 305 is shown in FIG. 3D.

Referring now to FIG. 3D, illustrated is a perspective view 300D of a fourth stage of an oral swab extraction process flow. As shown, when the oral care device is withdrawn from the container 305 after insertion into the oral swab 315, the oral swab 315 remains coupled to the cleaning portion 115. In some implementations, the oral swab 315 can be coupled to and cover the entirety of the cleaning portion 115. In some implementations, only a portion of the oral swab 315 can be coupled to the cleaning portion 115, but the oral swab 315 can still cover the entirety of the cleaning portion 115. However, in some implementations, the oral swab 315 can cover only a section of the cleaning portion 115. In some implementations, the oral swab 315 can cover more than the entirety of the cleaning portion 115, and can additionally cover a portion of the sleeve 110. The oral swab 315 can be coupled or affixed to the cleaning portion 115 such that when the cleaning portion 115 spins as part of the normal functioning of the oral care device, the oral swab remains fixed to the cleaning portion 115. The oral swab 315 can be permanently coupled to the cleaning portion 115. For example, the oral swab 315 can include one or more connectors that permanently couple the oral swab 315 to the cleaning portion 115, resulting in a unified body. Friction between the oral swab 315 and the walls of the container 305 can hold the oral swab 315 within the container until the oral swab 315 is coupled to the cleaning portion 115. Once the oral swab 315 is coupled to the cleaning portion 115, the force coupling the oral swab 315 to the cleaning portion 115 can overcome the force of friction holding the oral swab 315 in the container 305, allowing the oral swab 315 to be removed from the container 305.

In some implementations, the oral swab 315 can be removed manually from the cleaning portion 115. In implementations where the sleeve 110 and the cleaning portion 115 are disposable and the rest of the oral care device is not disposable, all of the sleeve 110, the cleaning portion 115, and the oral swab 315 can be manually removed from the hollow tube 120 and disposed of. A healthcare provider can then clean (e.g., sterilize, etc.) the remaining portions of the oral care device, and apply a new sleeve 110 having a new cleaning portion 115 for next use. Alternatively, everything shown in FIG. 3D may be disposable.

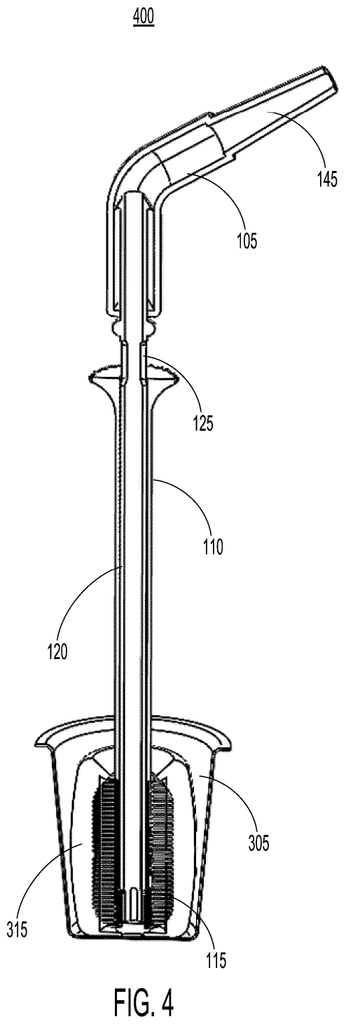

Referring now to FIG. 4, illustrated is a cross-sectional view 400 of the example oral care device extracting the swab from the example oral swab container 305 depicted in FIGS. 3A, 3B, 3C and 3D. As shown, the sleeve 110 of the oral care device is positioned such that the suction apertures 125 of the hollow shaft 120 are exposed, and the sleeve 110 is pressed against the end stop 135 at the end of the hollow shaft 120. In the view 400, the cleaning portion 115 of the oral care device has been inserted into the opening of the oral swab 315 via the opening of the container 305. In some implementations, the cleaning portion 115 can include one or more mechanical coupling features, such as a snap-fit connector, a friction fit connector, a press-fit connector, a threaded connector, or another type of mechanical connector. In some implementations, when the cleaning portion 115 includes bristles or portions having bristles, the bristles can press into and secure the oral swab 315 to the cleaning portion 115. For example, the bristles can be made of a rigid material that presses into and couples to the oral swab 315, which can be made of a soft material. The bristles of the cleaning portion 115 can become embedded into the oral swab 315, and because at least 50% of the surface of the cleaning portion 115 can have bristles (e.g., as depicted in FIG. 1C, etc.) the oral swab 315 can become coupled to the surface of the cleaning portion 115. The oral swab 315 can have elasticity to grip the cleaning portion 115. Any of the container 305, the sealing lid 310, or the oral swab 315 can each be formed from a disposable or recyclable material. For example, the container 305 can be manufactured from a recyclable plastic material, or from a biodegradable material.

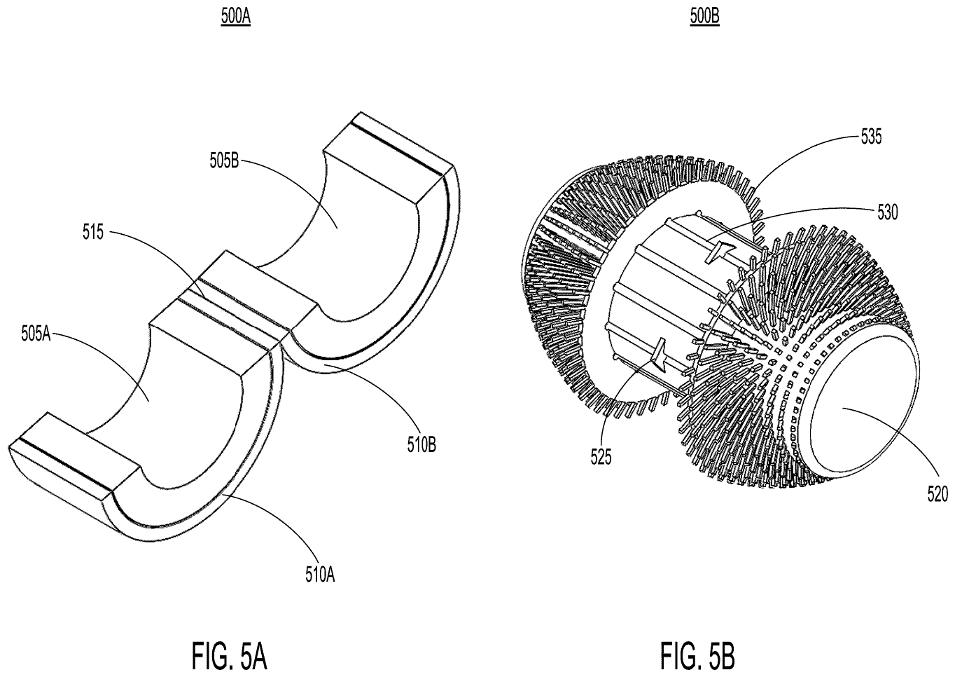

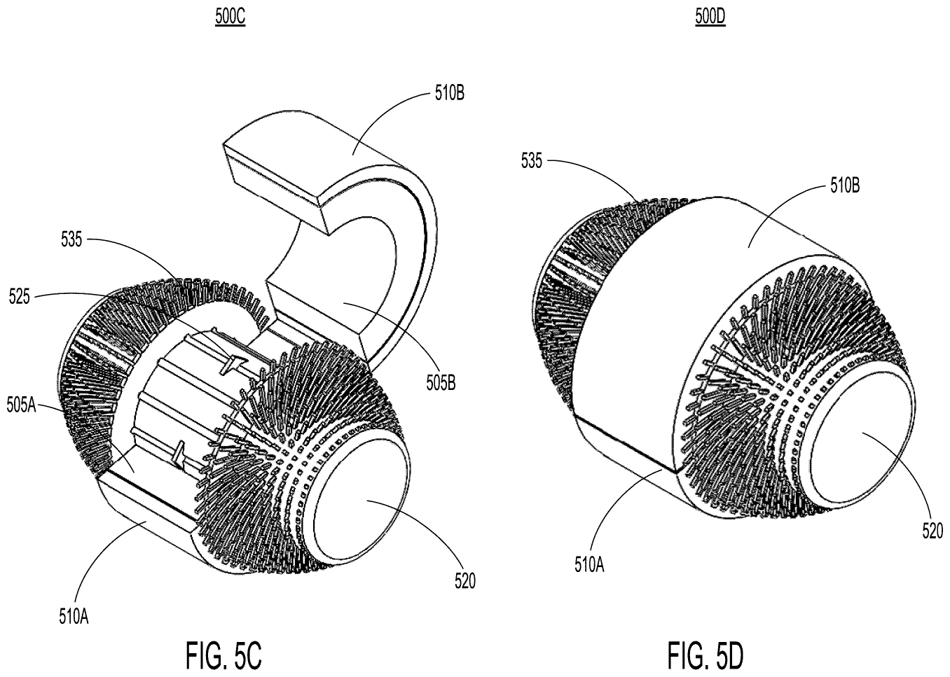

Referring now to FIG. 5A, illustrated is a perspective view 500A of an example fluid reservoir 505 having an outer layer 510. The fluid reservoir can include a treatment fluid, such as an oral cleaning solution, a disinfectant solution, or a hydrating solution (e.g., to hydrate a dry oral cavity of a patient, etc.). The liquid container shown in view 500A can include one or more discrete portions. For example, as shown in FIG. 5A, the liquid container is divided into two discrete semi-circular portions, the liquid container 505A and the liquid container 505B. Each of the liquid containers 505A and 505B can store the same liquid solution. In some implementations, each of the liquid containers 505A and 505B can store a different liquid solution. The containers 505A and 505B can be surrounded by respective outer layers 510A and 510B. Each of the outer layers 510A and 510B can be constructed from, for example, a soft material such as a foam material or a cotton-based material. In some implementations, the outer layers 510A and 510B can each be formed from a soft plastic material, or a soft rubber material. Each of the outer layers 510A and 510B can protect the liquid portions 505A and 505B from potential perforation while inserted into an oral cavity of a patient. The outer layers 510A and 510B are biologically safe materials, such that they do not harm the tissue of a patent while inserted into the patent's oral cavity. The liquid containers 505A and 505B can be held together by a connector 515, such as a hinge. The connector 515 can allow the liquid containers 505A and 505B be to easily coupled to a brush head, such as the brush head depicted in FIG. 5B.

Referring now to FIG. 5B, illustrated is a perspective view 500B of an example brush head having a perforator 525 and fluid channels 530. As shown, the brush head can include at least one receiving cavity 520 defined by the one or more walls of the brush head. The receiving cavity 520 can be, for example, a hole or a channel defined through the center of the brush head. Having the receiving cavity 520 in the center of the brush head allows the weight of the brush head to be evenly distributed about the radial axis of the brush head, thereby minimizing the occurrence of vibrations when the brush head rotates about its longitudinal axis. The receiving cavity 520 can receive and couple to a cleaning end of an oral care device, such as the oral care device depicted in FIGS. 1A, 1B, and 1C. The receiving cavity 520 can include one or more connectors that couple the cleaning end of the oral care device to the inside of the brush head. Some example connectors include a snap-fit connector, a friction fit connector, a press-fit connector, an adhesive disposed within the receiving cavity 520, or a threaded connector, among others.

As shown, the walls of the brush head can have a first end that includes one or more bristles 535. The bristles 535 can protrude outward from the one or more walls of the brush head, allowing the bristles to make contact with an oral cavity of a patient. Each of the bristles 535 can have a base portion that connects the bristle 535 to the wall of the brush head. In some implementations, one or more of the bristles 535 can include, or be proximate to, a base portion that is in fluid communication with the channels 530 of the central portion of the brush head. The base of a bristle can include a fluid channel outlet that is fluidly connected to one or more of the channels 530 of the central portion of the brush. The fluid channel outlet can allow fluids passing through one or more of the channels 530 to pass to a surface of the brush head and make contact with one or more of the bristles 535. This can, for example, facilitate cleaning operations performed using the brush head, by directly applying a cleaning solution to the bristles 535 of the brush head via the fluid channels 530.

The channels 530 of the brush head can be disposed in a central portion of the brush head, shown as the recessed region between both ends of the brush head in view 500B of FIG. 5B. Although the central portion is depicted as a recessed portion, it should be understood that the central portion of the brush need not necessarily be a recessed portion. The central portion can be any portion of the brush head that is configured to receive one or more liquid containers, such as the liquid containers 505A and 505B depicted in view 500A of FIG. 5A. Although the central portion is depicted as a recessed region in the center of the brush head, it should be understood that the portion need not necessarily be positioned in the central portion of the brush head, and can instead be disposed on any surface of the brush head. In some implementations, the brush head can include several portions that each receive a separate liquid container.

The central portion can include one or more perforators 525. The one or more perforators 525 can include, for example, one or more spikes or pointed features that protrude outward from the walls of the brush head. In some implementations, the one or more perforators 525 can include one or more needles, having channels disposed there that are fluidly coupled to the channels 530. The one or more perforators 525 can include a sharped edge that can cut, pierce, or otherwise puncture a liquid container or a liquid reservoir, such as the liquid containers 505A and 505B. Once the liquid containers are perforated by the one or more perforators 525, the fluid stored in the liquid container can flow along the one or more channels 530. As the one or more channels 530 are fluidly connected to the bases of the bristles 535, the one or more perforators 525 can cause fluid from the liquid containers to flow to the outer surface of the brush head and onto the bristles 535 via the one or more channels 530. The process of affixing one or more liquid containers (e.g., the liquid containers 505A and 505B) to the brush head is depicted in FIG. 5C.

FIG. 5C illustrates a perspective view 500C of the example fluid reservoir 505 shown in FIG. 5A being coupled to the example brush head shown in FIG. 5B. As shown, a healthcare provider can attach the liquid containers 505A and 505B shown in FIG. 5A to the brush head shown in FIG. 5B. The liquid containers 505A and 505B can be formed such that they can conform to the central portion of the brush head, causing the liquid containers 505A and 505B to be punctured by the one or more perforators 525. As described herein, the liquid containers 505A and 505B can be connected via a connector, such as a hinge. To couple the liquid containers 505A and 505B to the brush head, a healthcare provider can first couple one liquid container (e.g., the liquid container 505A, etc.) to the central portion of the brush head. The liquid containers 505A and 505B can connect to the brush head using one or more connectors, such as a snap-fit connector, a friction fit connector, a press-fit connector, or an adhesive disposed on the surface of liquid containers 505A and 505B or the central portion of the brush head. In some implementations, the friction caused by the perforator 525 puncturing the liquid containers 505A or 505B can hold the liquid containers 505A and 505B in place on the brush head. Once a first portion of the liquid containers 505A and 505B has been coupled to the brush head, a healthcare provider can couple the second portion (e.g., the liquid container 505B) to the brush head, as shown in FIG. 5D.

FIG. 5D illustrates a perspective view 500D of the example fluid reservoir 505 shown in FIG. 5A being coupled to the example brush head shown in FIG. 5B. As shown, once both the liquid containers 505A and 505B have been coupled to the brush head, the liquid containers 505A and 505B can surround the central portion of the brush head. Much like the liquid container 505A, the liquid container 505B can also be punctured by one or more of the perforators 525, causing fluid from the liquid container 505B to flow to the surface of the brush head via the channels 530, as described herein. Each of the liquid containers 505A and 505B can couple to one another using an additional connector, causing the liquid containers 505A and 505B to surround the brush head. For example, as described herein above, each of the liquid containers 505A and 505B can be coupled to one another using a first connector, such as a hinge. The hinge can be positioned at one end of both liquid containers 505A and 505B. An additional connector can be positioned at the opposite end of the liquid containers 505A and 505B, which can couple each of the liquid containers 505A and 505B together to form a ring configuration that surrounds the brush head. The additional connector can be, for example, a snap-fit connector, a friction fit connector, a press-fit connector, or an adhesive disposed on a surface of either of the liquid containers 505A or 505B. The additional connector can affix the liquid containers 505A and 505B in place once the liquid containers 505A and 505B are mounted on the brush head. In some implementations, the additional connector can be disconnected by the healthcare provider, and the liquid containers 505A and 505B can be removed from the brush head and discarded.

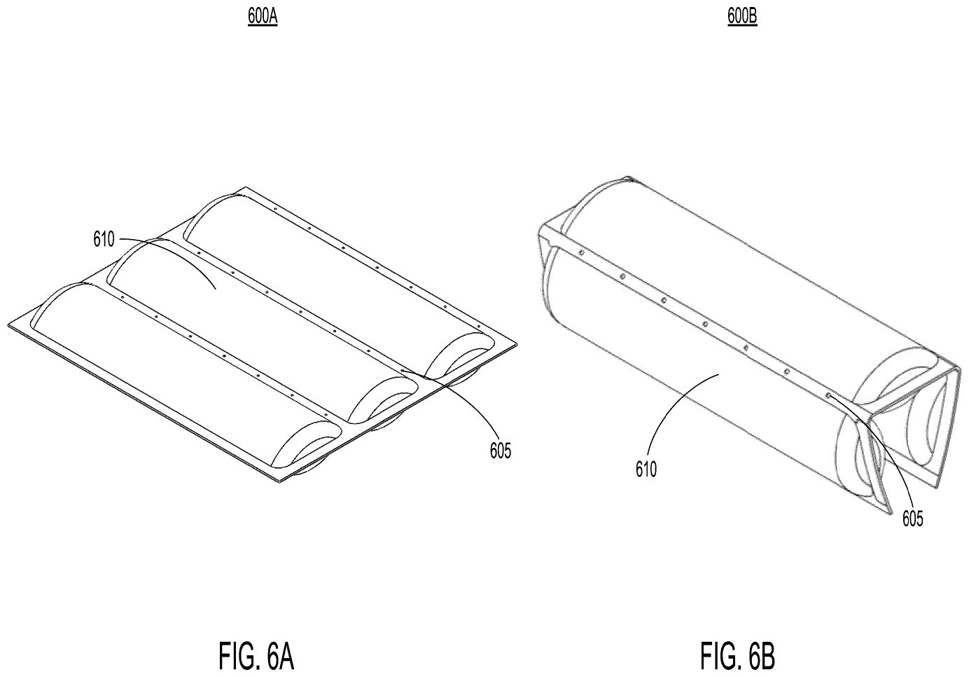

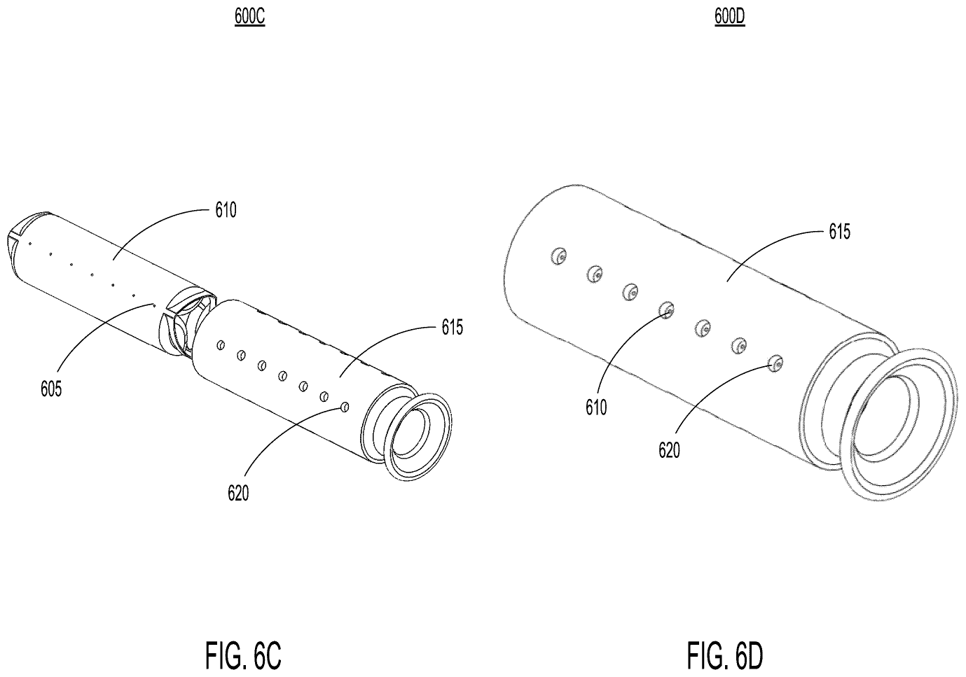

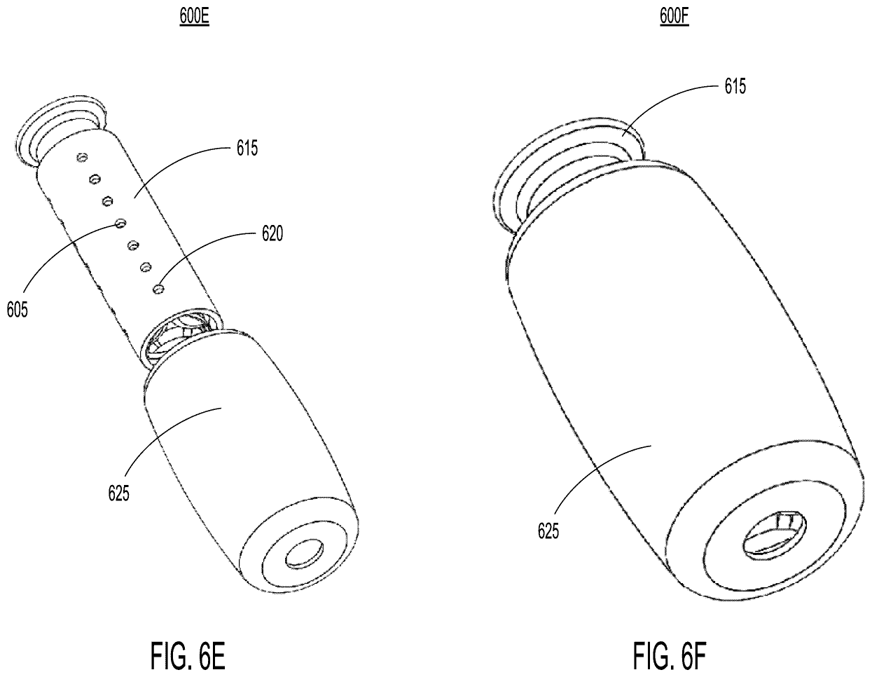

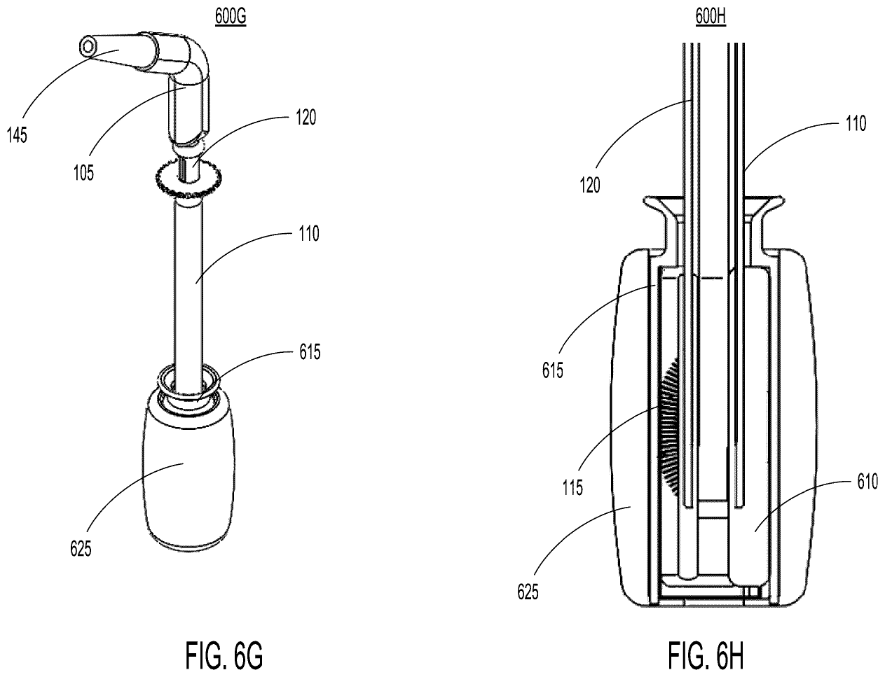

Referring now to FIGS. 6A and 6B, illustrated are perspective views 600A and 600B of a sachet container of fluid that can be used with the oral care device described herein. The sachet container can include one or more pre-fabricated layers that are coupled to one another via heat, an adhesive, or some other type of coupling. The pre-fabricated layers can define one or more tubes 610. As shown in FIG. 6A, the sachet container can include three tubes 610, but it should be understood that other numbers of tubes 610 are possible. The tubes 610 can contain an oral cleaning fluid, an oral disinfectant, or other fluids used in oral care procedures. The tubes can be separated by one or more perforations 605. The perforations 605 can include one or more holes, slots, or grooves. As shown in FIG. 6B, the sachet container can be folded along the perforations 605. The sachet container can fold along the perforations 605 such that the tubes 610 of the sachet container form a cylindrical shape, or another shape that conforms to an exterior sleeve 615 (described below). Once the sachet has been folded into the shape of the exterior sleeve 615 (here depicted as cylindrical) the sachet container can be inserted into an exterior sleeve, such as the exterior sleeve 615 depicted in FIG. 6C.

Referring now to FIGS. 6C and 6D, illustrated are perspective views 600C and 600D of the sachet container of FIGS. 6A and 6B being inserted into the exterior sleeve 615. As shown, the exterior sleeve 615 can be formed to accommodate the sachet container when the sachet container has been folded into its final form. As shown in FIGS. 6C and 6D, the exterior sleeve 615 can be substantially cylindrical, but it should be understood that other shapes are possible. The exterior container can include one or more exterior openings 620 that correspond to the perforations 605 of the sachet container. In some implementations, the exterior openings 620 can correspond to one or more of the holes, slots, or grooves present on the perforations 605. The exterior sleeve 615 can be sized such that it can fit snugly around the outer surface of the sachet container. In some implementations, an outer surface of the sachet container or an inner surface of the exterior sleeve 615 can include an adhesive or another type of coupling disposed thereon that facilitates coupling of the sachet container to the exterior sleeve 615. In some implementations, friction can couple the sachet container to the exterior sleeve 615 without any adhesive or coupling mechanism. As shown in FIG. 6D, when the sachet container has been positioned inside the exterior sleeve 615, the perforations 605 present on the sachet container can be aligned with the exterior openings 620 of the exterior sleeve 615. Once the sachet container has been positioned inside of the exterior sleeve 615, the exterior sleeve 615 can be inserted into an oral swab 625, as shown in FIGS. 6E and 6F.

Referring now to FIGS. 6E and 6F, illustrated are perspective views 600E and 600F of the exterior sleeve 615 being inserted into the oral swab 625. The oral swab 625 can be similar to the oral swab 315 described herein above in connection with FIGS. 3C and 3D. The oral swab 625 can be a dry swab comprising foam, sponge, or another type of porous material, such as cotton. The oral swab 625 can be capable of absorbing fluids, such as the fluids sealed in the tubes 610. The oral swab 625 can be used as part of an oral care procedure, and can include an opening near at least one end that can receive the exterior sleeve 615. The exterior sleeve 615 can be inserted into the opening of the oral swab 625, and the interior surface of the oral swab 625 can couple to the exterior surface of the exterior sleeve 615. In some implementations, the exterior sleeve 615 or the oral swab 625 can include one or more connectors, such as a friction-fit connector, a press-fit connector, or a snap-fit connector, among others. Once the exterior sleeve 615 has been inserted into the oral swab 625, an oral care device can be inserted into an opening of the exterior sleeve 615, as shown in FIGS. 6G and 6H.

Referring now to FIG. 6G, illustrated is a perspective view 600G of the oral care device of FIGS. 1A and 1B being inserted into the exterior sleeve 615 after being coupled to the oral swab 625. As shown, once the exterior sleeve 615 has been inserted into the oral swab 625, an opening in the exterior sleeve 615 can be exposed. The cleaning portion 115 of the oral care device can be inserted into the opening, which can compress and rupture the tubes 610 of the sachet device. In some implementations, the tubes 610 do not rupture, but instead the perforations 605 can break (for example, layers forming the tubes can delaminate), such that fluid from the tubes 610 can flow out of the holes or slots present on the broken perforations 605. The fluid present in the tubes 610 of the sachet device can flow out of the perforations of the sachet device, which as shown in FIG. 6D, are aligned with the exterior openings 620 of the exterior sleeve 615. Thus, the fluid can flow out of exterior openings 620 of the exterior sleeve 615 and soak into the oral swab 625. The oral swab 625 can absorb the fluid, and the oral swab 625 can then be used in an oral care procedure. A cross-sectional view 600H of the oral care device being inserted into the exterior device 615 is depicted in FIG. 6H.

Referring now to FIG. 6H, illustrated is a cross-sectional view 600H of the oral care device being inserted into the exterior sleeve coupled to the oral swab 625. As described herein above, the oral swab can couple to the outer surface of the exterior sleeve 615. The opening of the exterior sleeve 615 can remain exposed even when inserted into the oral swab 625. The opening of the exterior sleeve 615 can receive the cleaning portion 115 of the oral care device. In some implementations, the exterior sleeve 615 can include one or more connectors that couple to the cleaning portion 115 of the oral care device, such as a snap-fit connector, a friction-fit connector, or a press-fit connector, among others. In some implementations, friction between the cleaning portion 115 and the one or more tubes 610 of the sachet container can cause the cleaning portion 115 to remain coupled to the exterior sleeve 615. The cleaning portion 115 can extend outward and press into the tubes 610 of the sachet container, causing the fluid in the tubes 610 to flow out of the holes 620 of the exterior sleeve 615 and soak into the oral swab 625.

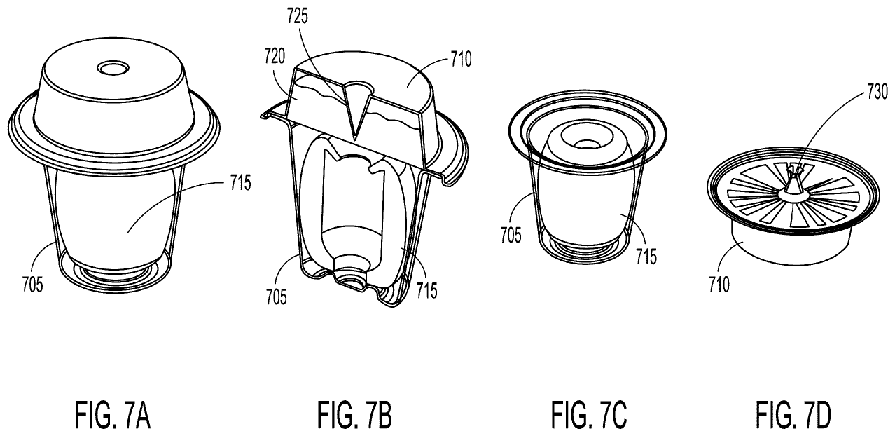

Referring now to FIGS. 7A, 7B, 7C, and 7D, illustrated are various views of an example oral swab container 705 with a separate fluid container 710, in accordance with one or more implementations. Referring to FIG. 7A, illustrated is an oral swab container 705, which may be similar to, and include any of the structure of, the oral swab container 305 described in connection with FIGS. 3A-3D. As shown, the oral swab container 705 includes an oral swab 715, which may be similar to, and include any of the structure of, the oral swab 315 described in connection with FIGS. 3A-3D. The oral swab container 705 differs from the oral swab container 305 of FIGS. 3A-3D in that liquid may not be stored in the oral swab container 705. Instead, liquid used in connection with the oral swab 715 is stored in a separate liquid container 710.

As shown in FIG. 7B, the liquid container 710 includes a sharp portion 725 that can puncture a wall or protective film on the liquid container 710 to release fluid 720 contained therein. Any type of liquid, gel, or material can be stored as the fluid 720 in the liquid container 710, including chlorhexidine (CHX), mouth rinse solution, a toothpaste solution, or any other type of oral-hygiene related material. FIG. 7C shows a perspective view of the oral swab container 705, with the oral swab 715 contained therein, with the liquid container 710 removed. FIG. 7D illustrates an alternative view of the liquid container 710, which shows a bottom wall 730 that includes a weakened portion at the center. The weakened portion of the bottom wall 730 can be pierced by the sharp portion 725, releasing the fluid 720 from the liquid container 710. A foil or protective film may also be used. The oral swab container 705 or the liquid container 710 may include a mechanical snap-fit edge, which can couple the liquid container 710 to the oral swab container 705.

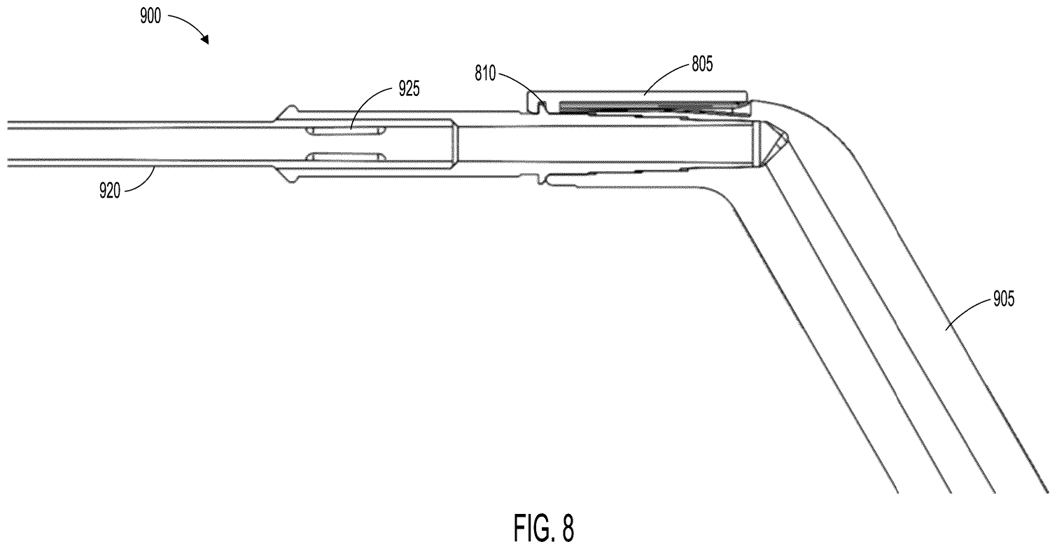

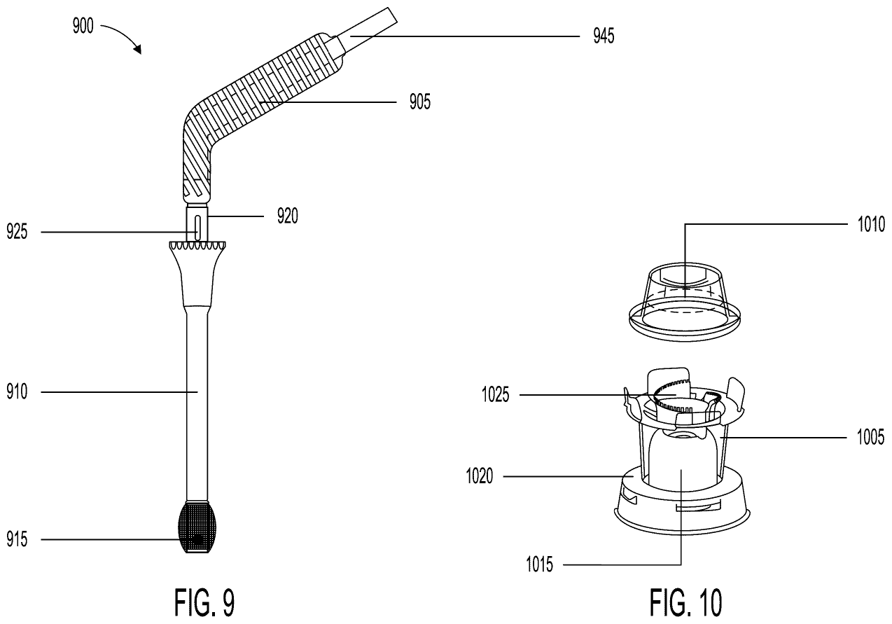

Referring now to FIG. 8, illustrated is a cross-sectional view of a modular grip 905 for an example oral care device 900 described in connection with FIG. 9, having a sleeve portion, in accordance with one or more implementations. As shown, the oral care device includes a hollow shaft 920, suction apertures 925, and a grip portion 905, each of which are described in greater detail in connection with FIG. 9. Additionally, the grip portion 905 includes a clip 805, which couples the grip portion 905 to the hollow shaft 920. The hollow shaft 920 includes a lip 810, which slides into a corresponding slot of the clip 805 on the grip 905. The clip may include a spring at an end opposite to the slot, such that the clip 805 may be compressed at the end opposite to the slot to release the lip 810 from the slot. The clip 805 may be a snap-fit connector, and may make a clicking noise when the hollow shaft 920 has been sufficiently inserted into the grip portion 905.

FIG. 9 illustrates a side view of an alternative oral care device 900 having a sleeve portion 910, in accordance with one or more implementations. The oral care device 900 can be similar to the oral care device described in connection with FIGS. 1A-2B. The oral care device 900 can include brush head 915, which can be similar to, and include any of the structure of, the brush head 115 described in connection with FIGS. 1A-2B. The oral care device 900 can include a grip portion 905, a suction pipe fitting 945, and a hollow shaft 920. The hollow shaft 920 can be surrounded by the sleeve portion 910, similar to the configuration of the hollow shaft 120 described in connection with FIGS. 1A-2B. The hollow shaft 920 can include one or more suction apertures 925, which can be similar to and include any of the structure of the suction apertures 125 described herein. The grip portion 905 can include a rough or patterned surface, to reduce slipping when held in the hand of a dental professional. The oral care device 900 can be a modular device, where the hollow shaft 920 (and the sleeve portion 910 and the brush head 915 coupled thereto) can be separated from the grip portion 905. The hollow shaft 920 can couple to the grip portion utilizing one or more connectors, such as a snap-fit connector. The hollow shaft 920 can be in fluid communication with the suction pipe fitting 945 through one or more channels or tubes (not shown) inside the grip portion 905.

FIG. 10 illustrates a perspective view of yet another alternative oral swab container 1005 with yet another alternative separate fluid container 1010, in accordance with one or more implementations. The oral swab container 1005 can be similar to the oral swab container 705 described in connection with FIGS. 7A-7D. However, the oral swab container 1005 can include one or more perforators 1025 at the top of the oral swab container 1005. As shown in FIG. 10, the perforators 1025 are formed in a pointed spiral shape, and can perforate a protective wall or protective film (not shown) of a liquid container 1010. The oral swab container 1005 can include an oral swab 1015, which may be similar to and include any of the structure of the oral swab 315 described in connection with FIGS. 3A-4. The oral swab container 1005 may be coupled to or placed into a base structure 1020.

The liquid container 1010 can be structurally similar to the liquid container 710 described in connection with FIGS. 7A-7D. However, the liquid container 1010 may not include a perforator as in FIGS. 7A-7D, and may instead be perforated by the perforators 1025 of the oral swab container 1005. To perforate the liquid container 1010, a user can apply a downward force to the liquid container 1010, pressing it against the perforators 1025. The base structure 1020 can support the oral swab container 1005 when the force is applied. In some implementations, the force can be applied in a twisting motion, and the perforators 1025 can become embedded in the wall or protective film on the liquid container 1010. Then, when the liquid container 1010 is removed after the oral swab 1015 has been saturated with the fluid in the liquid container 1010, the perforators 1025 can be coupled to the film and be removed with the liquid container 1010. For example, the perforators 1025 may be coupled to the oral swab container 1005 at one or more weak points, which are designed to fail in response to an applied force that also pierces the film of the liquid container 1010. Removing the perforators 1025 exposes the saturated oral swab 1015, which can then be coupled to an oral care device for an oral care procedure.

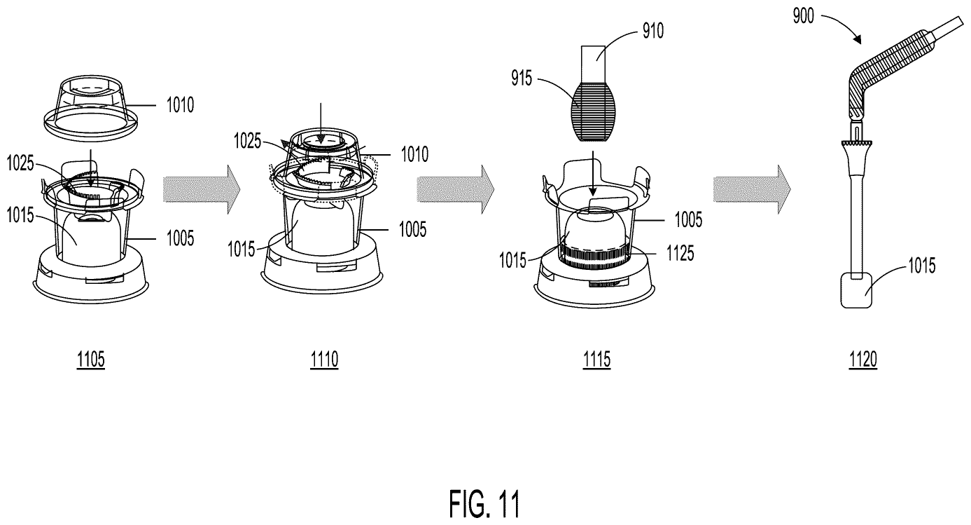

FIG. 11 illustrates an example process of utilizing the example oral care device 900 shown in FIG. 9 with the oral swab container 1005 and fluid container 1010 shown in FIG. 10, in accordance with one or more implementations. The process can begin at step 1105, where the liquid container 1010 can be pressed downward onto the perforators 1025. At step 1110, a downward twisting force can be applied to the liquid container 1010, and the perforators 1025 can pierce the protective film or wall of the liquid container 1010. At step 1115, the twisting force can separate the perforators 1025 from the oral swab container 1005, and the perforators 1025 can remain embedded in the protective wall or film of the liquid container 1010. The liquid container 1010 can then be removed, leaving the oral swab 1015 exposed while saturating in the fluid 1125 that has escaped the liquid container 1010. The brush head 915 coupled to the sleeve portion 910 of the oral care device 900 can be inserted in the opening of the oral swab 1015, and removed from the oral swab container 1005, as shown in step 1120.

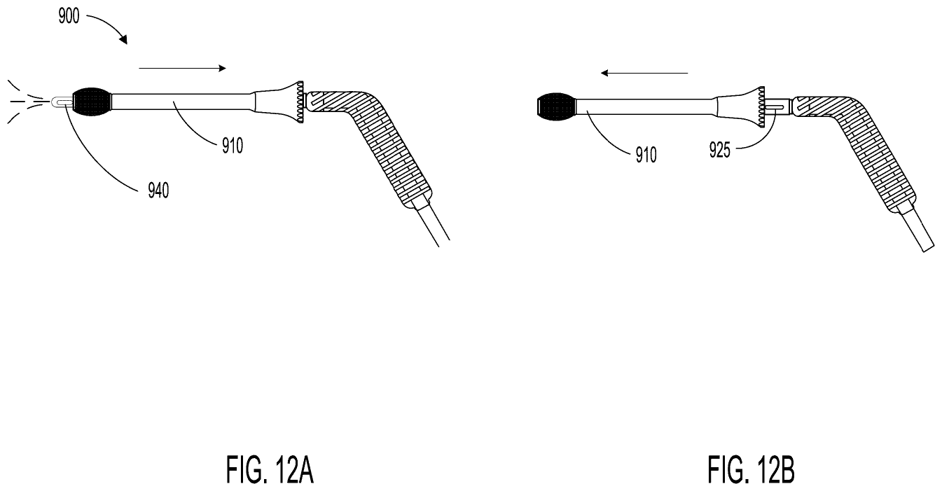

FIGS. 12A and 12B show side views of the example oral care device 900 shown in FIG. 9, with the sleeve portion in different positions, in accordance with one or more implementations. As described herein, the oral care device 900 is similar to the oral care device described in connection with FIGS. 1A-2B. As shown, the oral care device 900 includes a sliding outer sleeve portion 910, which can slide over the hollow shaft 920 (omitted here for visual clarity, but described in connection with FIG. 9) to expose the suction apertures 925 or a second set of suction apertures 940. FIG. 12A shows the sleeve portion pulled back to expose the second set of suction apertures 940, while FIG. 12B shows the sleeve portion pushed forward to expose the suction apertures 925. This is similar to the arrangements described in connection with FIGS. 2B and 2A, respectively.

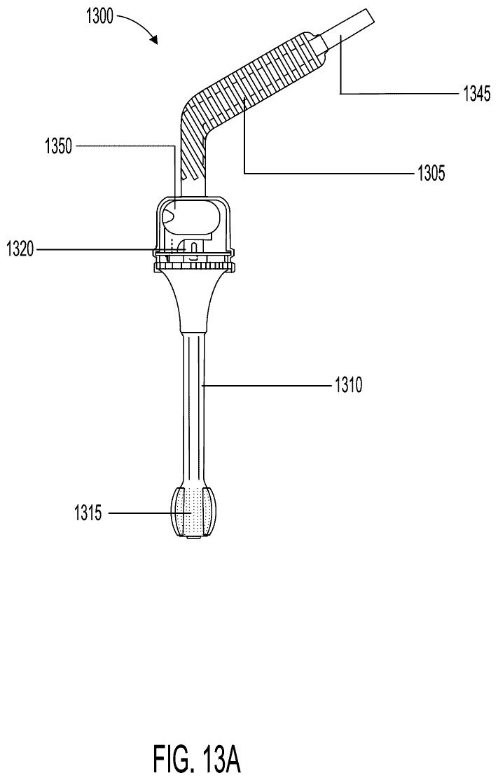

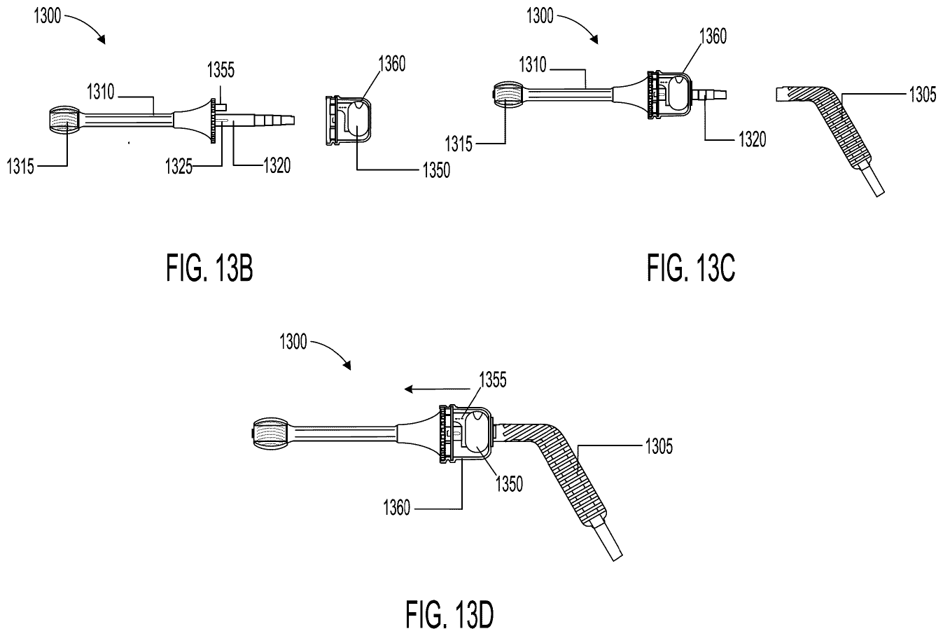

FIG. 13A illustrates a cross-sectional view of an example oral care device 1300 with an integrated fluid reservoir, in accordance with one or more implementations. The oral care device 1300 can include a grip portion 1305 and a suction pipe connector 1345, which can be structurally similar to the grip portion 905 and the suction pipe connection 945 described in connection with FIG. 9. The oral care device 1300 can include a hollow tube 1320 that is fluidly coupled to the suction pipe connector 1345, and a sleeve portion 1310 that surrounds the hollow tube 1320. The sleeve portion 1310 can surround the hollow tube 1320 such that a fluid channel is formed between the sleeve portion 1310 and the hollow tube 1320. The fluid channel can be fluidly coupled to an integrated reservoir 1350, which may contain, for example, CHX, a mouth rinse solution, or any other oral hygiene-related substance. The integrated reservoir 1350 may be a donut shaped reservoir that surrounds the hollow tube 1320.

The oral care device 1300 can include a brush head 1315, which may be structurally similar to the brush head 915 described in connection with FIG. 9. The brush head 1315 may include one or more openings (not pictured), which are in fluid communication with the channel formed between the hollow tube 1320 and the sleeve portion 1310. The fluid from the integrated reservoir 1350 can travel down the channel and out of the openings in the brush head 1315. The fluid may saturate an oral swab that is coupled to the brush head 1315, or may provide a fluid solution to a mouth of a patient during an oral care procedure.

FIGS. 13B, 13C, and 13D illustrate example views of a modular implementation of the example oral care device shown in FIG. 13A, in accordance with one or more implementations. FIG. 13B shows a portion of a modular implementation of the oral care device 1300. As shown, the oral care device may include several modular components, which may be exchanged as needed. The hollow tube 1320, the sleeve portion 1310, and the brush head 1315 can form a first portion of the oral care device 1300. As shown, when disassembled, a set of suction apertures, similar to the suction apertures 925 described in connection with FIG. 9, are exposed. The suction apertures can be in fluid communication with the hollow portion of the hollow tube 1320. Additionally, as shown, a channel connector 1355 is exposed, which can fluidly couple the fluid reservoir 1350 to the channel formed between the hollow tube 1320 and the sleeve portion 1310. The integrated reservoir 1350 can be housed inside a housing 1360, which may include one or more connectors (e.g., a snap-fit connector, etc.) that couple to one or more of the hollow tube 1320 or the sleeve portion 1310. The integrated reservoir 1350 can include a connector, which couples to the channel connector 1355.

FIG. 13C shows the reservoir housing 1360 coupled to the hollow tube 1320 (or in some implementations, to the sleeve portion 1310). Additionally, although not shown here, the channel opening can be connected to the integrated reservoir 1350, allowing fluid to flow through the channel and to the brush head 1315. As shown, the housing 1360 may have a central opening that surrounds the hollow tube 1320, exposing an end portion of the hollow tube 1320 which may couple to the grip portion 1305. FIG. 13D shows the grip portion 1305 of the oral care device coupled to the hollow tube 1320, forming the completed oral care device 1300.

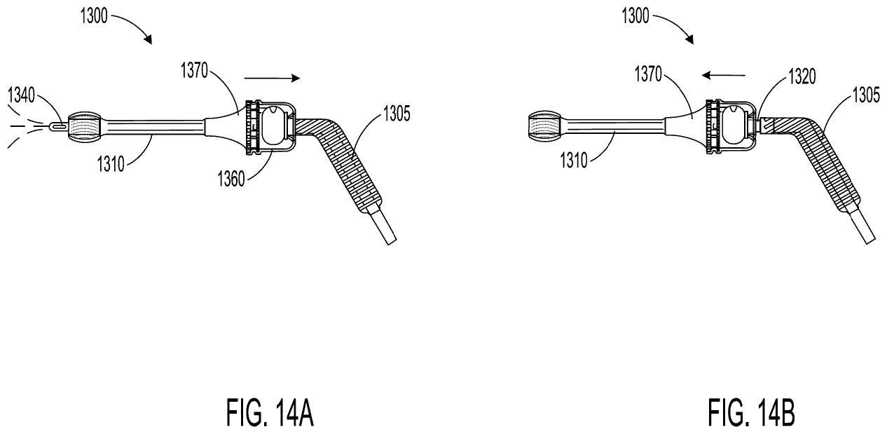

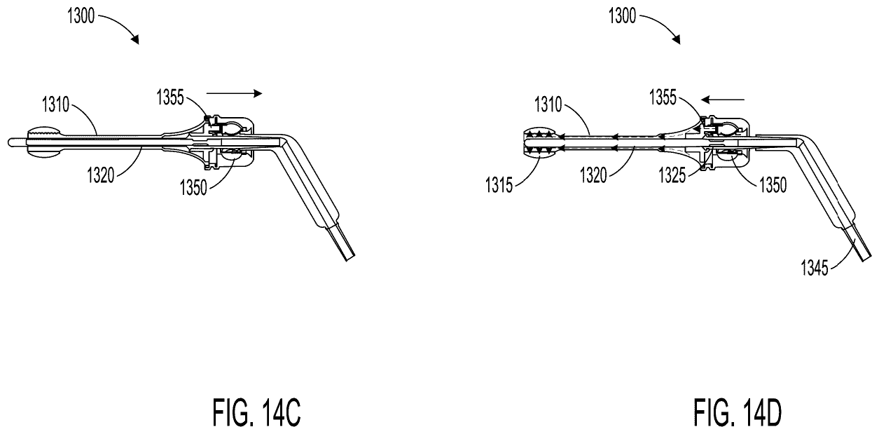

Referring to FIGS. 14A and 14B, illustrated are side views of the example oral care device 1300 shown in FIGS. 13A-13D. FIGS. 14A and 14B depict arrangements that are similar to the arrangements depicted in FIGS. 12A and 12B, but instead showing the oral care device 1300. As shown, the sleeve portion 1310 can be moved to different positions to expose either the second set of suction apertures 1340 (as in FIG. 14A) or to obstruct the second set of suction apertures 1340. When the sleeve portion 1310 is pulled backward, it may retract into a shroud portion 1370, which itself may be coupled to the housing 1360. A friction seal may be created between the sleeve portion 1310 and the shroud 1370. The shroud 1370 may include one or more channels or tubes that fluidly couple the channel connector 1355 (not shown here) to the channel formed between the sleeve portion 1310 and the hollow tube 1320. When the sleeve portion 1310 obstructs the second set of suction apertures 1340, the suction apertures 1340 may be sealed such that fluid does not flow into or out of the suction apertures 1340. In some implementations, the sleeve portion 1310 may not retract into the shroud portion 1370, and may instead travel along the hollow shaft 1320 toward the grip portion 1305, as shown.

Referring to FIGS. 14C and 14D, illustrated are cross-sectional side views of the example oral care device shown in FIGS. 14A and 14B, in accordance with one or more implementations. As shown, FIG. 14C corresponds to FIG. 14A, in that the sleeve portion 1310 has been retracted to expose an end portion of the hollow tube 1320. The cross-sectional view of FIG. 14C shows that the channel connector 1355 is coupled to the reservoir 1350. As shown in FIG. 14D, when the sleeve 1310 is pushed forward to obscure the suction apertures 1340 (reference number omitted for visual clarity), the fluid in the integrated reservoir 1350 can be forced through the channel connector 1355, through the channel, and out of the brush head 1315. The fluid reservoir may be forced by a positive pressure provided through the suction pipe connector 1345 and out of the apertures 1325. Because the suction apertures 1340 are sealed, the positive pressure escapes from the apertures 1325 and presses on the reservoir 1350, causing the fluid stored therein to flow through the channel connector 1355, through the channel, and out of the brush head 1315. Alternatively, forward motion of the sleeve 1310, as shown in FIG. 14D, can cause the integrated reservoir 1350 to become compressed, forcing the fluid stored therein to flow through the channel connector 1355, through the channel, and out of the brush head 1315.

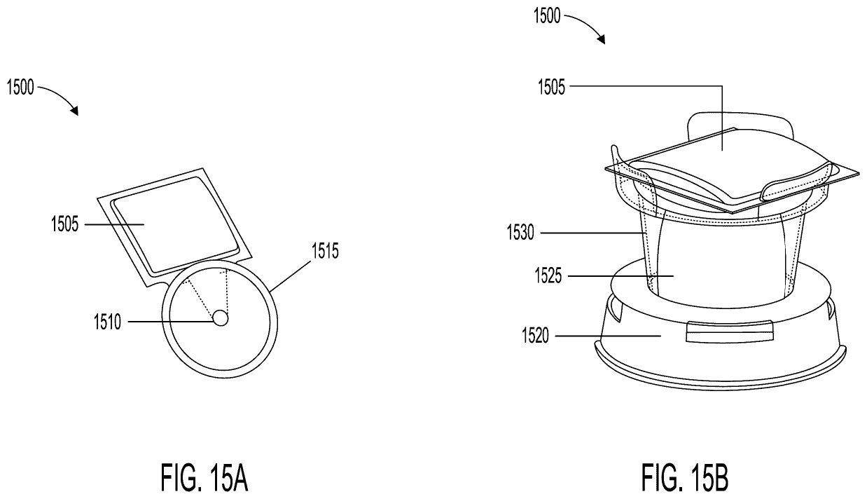

Referring to FIGS. 15A and 15B, illustrated are views of an example sachet container 1500 and oral swab container 1530 with a base portion 1520, in accordance with one or more implementations. FIG. 15A shows an example of the sachet container 1500, which may include a fluid container 1505, an opening 1510, and an outer ring 1515. The sachet container 1500 may be constructed from any suitable material, such as flexible plastic, foil, or composite material, and may be similar to the sachets described in connection with FIGS. 6A and 6B. The fluid container 1505 of the sachet container 1500 can include any type of oral hygiene-related fluid, including CHX, mouth rinse, or another substance. Use of a sachet provides the correct amount of liquid for each oral care session. A disadvantage of storing an oral care liquid with a brush or a swab is that compatibility of the liquid with the brush and swab materials over long storage periods must be established. Use of a sachet overcomes this disadvantage.

The sachet container 1500 may include a channel that connects the opening 1510 to the fluid container 1505. The channel may be blocked or sealed, for example, by a weakened portion of a sidewall of the fluid container 1505 that is configured to rupture in response to an appropriate force on the fluid container 1505. Upon rupturing, the fluid in the fluid container 1505 can flow into the channel and out of the opening 1510. The channel can be defined between two layers of material, which are coupled by the outer ring 1515 (e.g., through thermocompression, an adhesive, or another attachment process, etc.). One of the two layers of material can include the opening 1510, which is in fluid communication with the channel, while the other layer may be solid, allowing the fluid to be directed out of the sachet container 1500 in a single direction.

As shown in FIG. 15B, the sachet container 1500 may be utilized with an oral swab container 1530. The oral swab container 1530 may be similar to the oral swab container 1005 described in connection with FIG. 10. However, the oral swab container 1530 may not include perforators 1025 as described in FIG. 10, but instead may include a flat edge portion on which the sachet container 1500 can rest, as shown. The outer ring portion 1515 can fold under the fluid container, directing the opening 1510 downward towards an oral swab contained in the oral swab container 1530. The oral swab container 1530 may include a base portion 1520, which may be similar to the base portion 1020 described in connection with FIG. 10. A downward force can be applied to the sachet container 1500, causing the fluid to flow out of the opening 1510 to saturate the oral swab 1525.

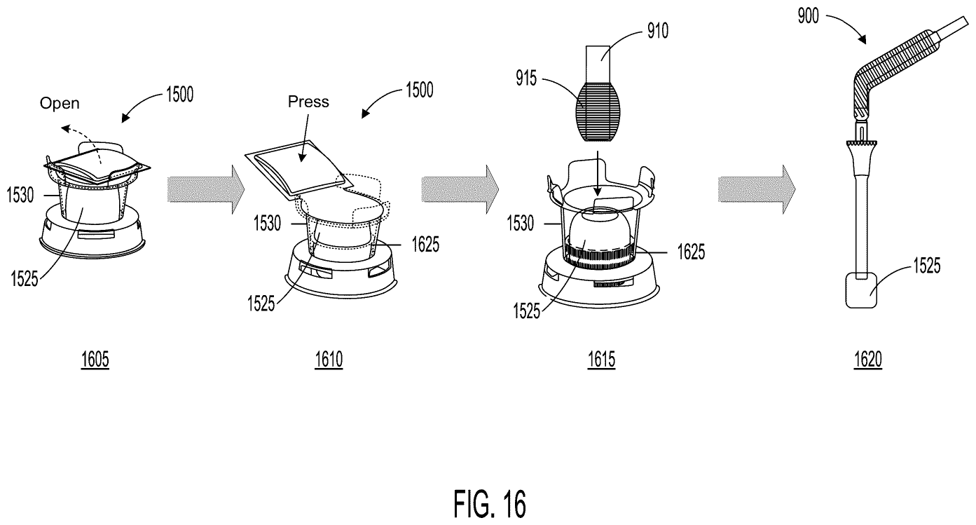

Referring now to FIG. 16, illustrated is an example process of utilizing the example sachet container 1500 and oral swab container 1530 depicted in FIGS. 15A and 15B with the example oral care device 900 shown in FIG. 9, in accordance with one or more implementations. The process can begin at step 1605, where the outer ring 1515 can be coupled to the top portion of the oral swab container 1530. The fluid container 1505 can be pulled upwards to separate the fluid container 1505 from the outer ring 1515, which remains coupled to the top of the oral swab container 1530. At step 1610, a force can be applied to the fluid container 1505, and the fluid contained therein can rupture the weak portion of the sachet container 1500 and the fluid 1625 can flow out of the opening 1510 (not pictured) and into the oral swab container 1530. At step 1615, the sachet container 1500 can be removed from the top of the oral swab container 1530, exposing the oral swab 1525, which has become saturated with the fluid 1625. The brush head 915 coupled to the sleeve portion 910 of the oral care device 900 can be inserted in the opening of the oral swab 1525, and removed from the oral swab container 1530, as shown in step 1620.

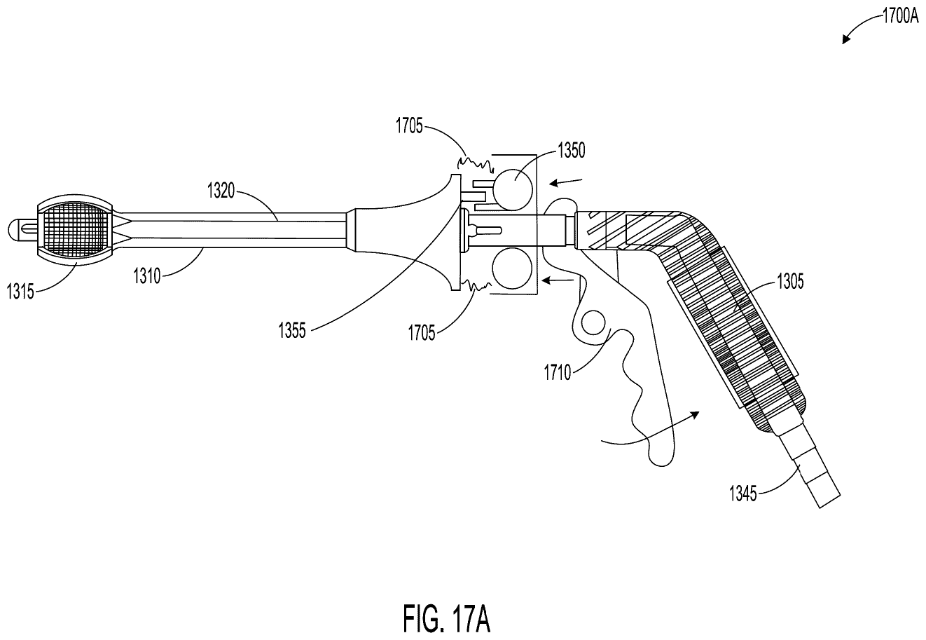

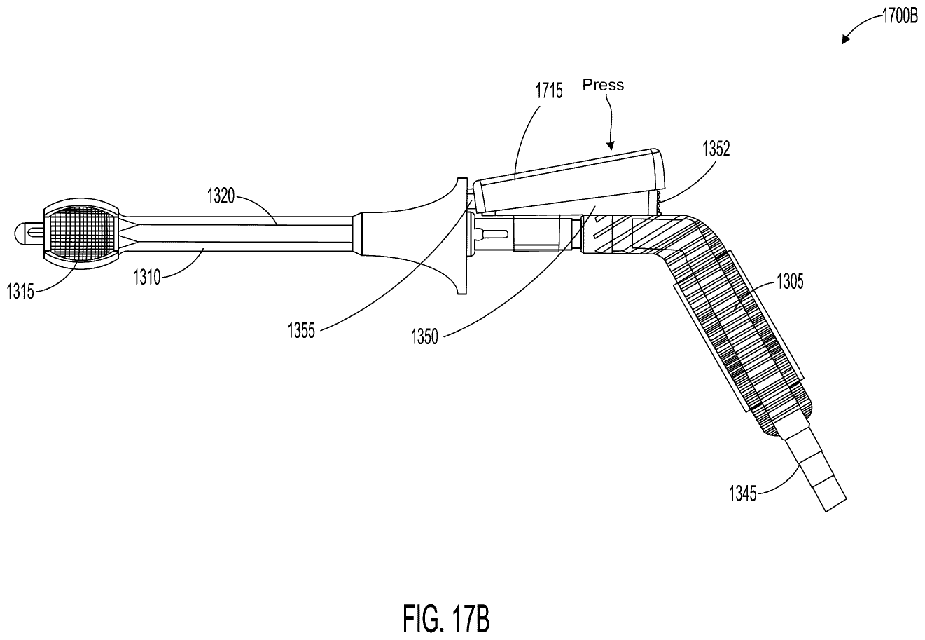

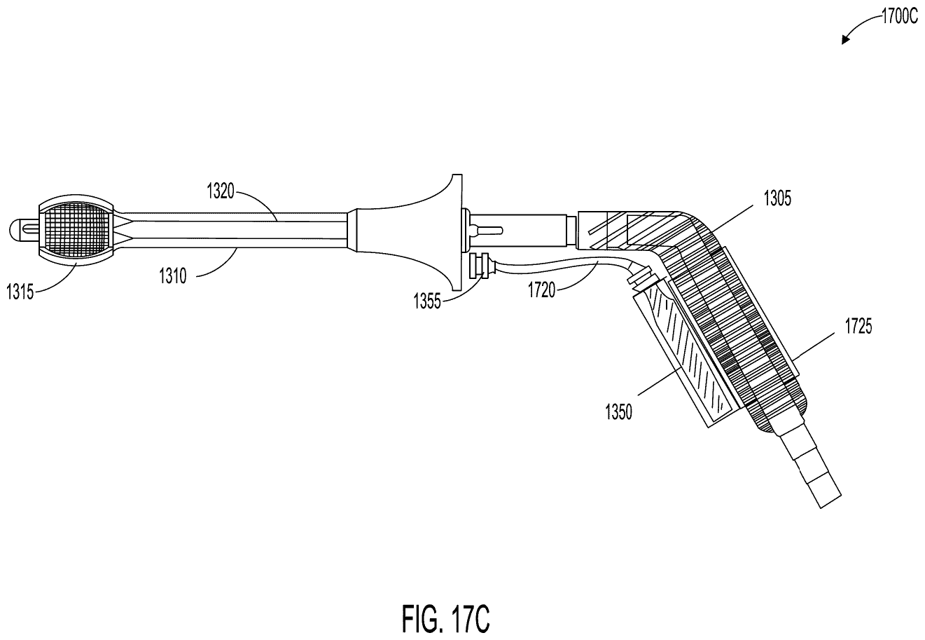

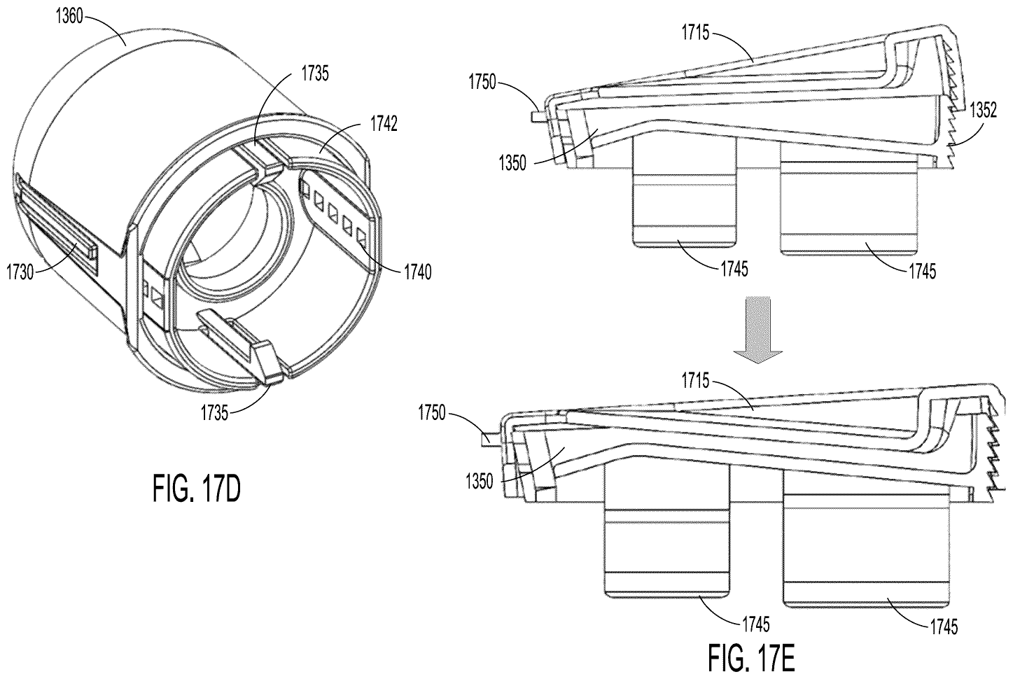

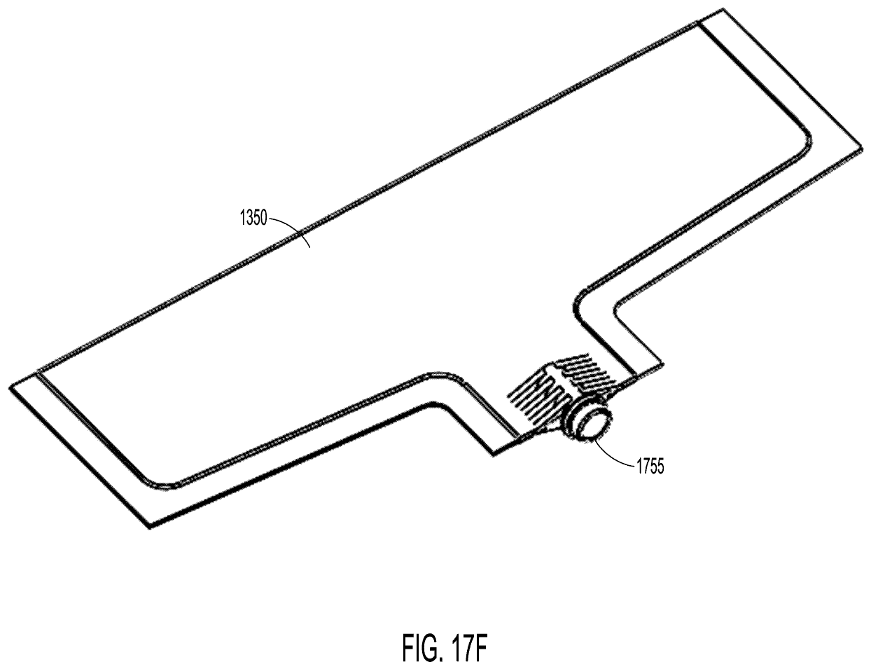

Referring now to FIGS. 17A, 17B, and 17C, illustrated are cross-sectional side views of oral care devices (e.g., similar to the oral care device 1300 described in connection with FIGS. 13A-13D) with integrated fluid reservoirs 1350 and various dispenser mechanisms, in accordance with one or more implementations. FIG. 17A shows an oral care device 1700A, which is similar to the oral care device 1300 of FIGS. 13A-13D, but utilizing a spring-based dispenser mechanism. As shown, the oral care device 1700A includes the brush head 1315, the sleeve portion 1310, the hollow tube 1320, the integrated reservoir 1350, the grip portion 1305, and the suction pipe connector 1345. As shown, the channel connector 1355 is fluidly coupled to the reservoir 1350.

FIG. 17A shows an oral care device 1700A, which is similar to the oral care device 1300 of FIGS. 13A-13D, but utilizing a spring-based dispenser mechanism. The oral care device 1700A includes a trigger mechanism 1710 to compress the reservoir 1350 toward the brush head 1315. The springs 1705 may compress the reservoir 1350 when the trigger mechanism 1710 is pulled backward toward the grip portion 1305. The sleeve portion 1310 can remain in place, and the housing including the reservoir 1350 can be pushed forward toward the brush head 1315 to compress the reservoir 1350 and the springs 1705. In some implementations, the springs 1705 may be a series of snap-fit connectors, which produce a clicking sound as the reservoir 1350 is compressed. Such snap-fit connectors are described in further detail in connection with FIG. 17D. When the reservoir 1350 is compressed, the fluid contained therein flows through the channel connector 1355 and into the channel defined between the hollow tube 1320 and the sleeve portion 1310. The trigger mechanism 1710 can be operated while holding the grip portion 1305. The trigger mechanism 1710 pivots on an axis, and when actuated, presses the housing forward to compress the integrated reservoir 1350. When the reservoir 1350 is compressed, the fluid contained therein flows through the channel connector 1355 and into the channel defined between the hollow tube 1320 and the sleeve portion 1310. The trigger may then be released, and the springs 1705 can move the housing back to a neutral position.

FIG. 17B shows an oral care device 1700B, which is similar to the oral care devices 1700A of FIG. 17A but utilizing an alternative integrated reservoir 1350 and compression mechanism 1715. The compression mechanism 1715 can include a housing that stores the integrated reservoir 1350. When a downward force is applied to the compression mechanism 1715, the alternative integrated reservoir 1350 is compressed, forcing the fluid contained therein through the channel connector 1355 and through the channel defined between the hollow tube 1320 and the sleeve portion 1310. The compression mechanism 1715 may include a spring, which causes the compression mechanism 1715 to return to its original position after being compressed. The integrated reservoir 1350 may be provided with ribs 1352, which mate with compression mechanism 1715 and “click” as the compression mechanism passes over each rib, to allow discrete amounts of fluid to be output.

FIG. 17C shows an oral care device 1700C, which is similar to the oral care devices 1700A and 1700B of FIGS. 17A and 17B, but utilizing an alternative integrated reservoir 1350 that is manually compressed by the operator of the oral care device 1700C. As shown, the integrated reservoir 1350 is fluidly coupled to the channel connector 1355 via the tubing 1720. The integrated reservoir 1350 is coupled to the grip portion 1305 using a connector 1725, which may be a rigid connector, an adhesive, a tape, or another attachment mechanism. When a user of the oral care device 1700C is holding the grip portion 1305, they may compress the integrated reservoir 1350, forcing the fluid contained therein through the tubing 1720, into the channel connector 1355, and through the channel defined between the hollow tube 1320 and the sleeve portion 1310.

Referring now to FIGS. 17D and 17E, illustrated are various views of mechanisms that may be used in connection with the oral care devices described herein (e.g., the oral care device 1300, 1700A, 1700B, etc.) to dispense fluid, in accordance with one or more implementations. FIG. 17D shows a perspective view of the housing 1360, which may be utilized in connection with the oral care devices 1300 and 1700A. The housing 1360 may be used to contain and dispense fluid from the reservoir 1350 (not shown). As shown, the housing 1360 includes an inner portion 1742, which includes clips 1735 that couple the housing 1360 to an oral care device (e.g., the oral care device 1300 or 1700A, etc.). The housing 1360 couples to the inner portion 1742 using the snap-fit connectors 1730 (one of which is not visible and positioned on the opposite side of the housing 1360). The snap-fit connectors 1730 can snap into the corresponding openings 1740 of the inner portion. The housing 1360 may be pressed forward, for example, by a finger or thumb of an operator of the oral care device, while the inner portion 1742 of the housing 1360 remains stationary and attached to an oral care device. This causes a reservoir positioned within the housing and behind the inner portion 1742 to become compressed by the housing 1360 as the housing slides forward along each of the openings 1740, dispensing the liquid from the reservoir as described herein. The openings 1740 may be spaced apart by a predetermined distance to dispense a predetermined volume of the liquid in the reservoir. As the snap-fit connectors 1730 snap into the corresponding openings 1740, a “click” noise may be generated, providing auditory feedback regarding the amount of fluid being dispensed to an operator of the oral care device.

FIG. 17E shows side views of the compression mechanism 1715 of FIG. 17B.

The compression mechanism 1715 can include a housing that stores the integrated reservoir 1350. The connectors 1745 can be used to couple the compression mechanism 1715 to the hollow shaft 1320 (not pictured) and the grip portion 1305 (not pictured) of an oral care device (e.g., the oral care device 1700B). The compression mechanism 1715 can include a housing that contains the integrated reservoir 1350. When a downward force is applied to the compression mechanism 1715, the integrated reservoir 1350 is compressed, forcing the fluid contained therein through an outlet 1750. The compression mechanism 1715 may include a spring, which causes the compression mechanism 1715 to return to its original position after being compressed. The integrated reservoir 1350 may be provided with ribs 1352, which mate with compression mechanism 1715 and “click” as the compression mechanism passes over each rib, to allow discrete amounts of fluid to be output.

Referring to FIG. 17F, illustrated is a perspective view of an example reservoir 1350 that may be utilized in connection with the fluid dispenser mechanisms described herein, such as the housing 1360 described in connection with FIGS. 13A-14D and 17A. The reservoir 1350 may be formed from a flexible material that enables the reservoir to be wrapped in an annular configuration and inserted into a housing, such as the housing 1360. The reservoir 1350 can contain a predetermined volume of fluid, and can include a connector 1755 that fluidly couples the reservoir 1350 to one or more channels of an oral care device. The connector 1755 may be a Luer connector, a snap-fit connector, a friction fit connector, a threaded connector, or any other type of suitable connector.

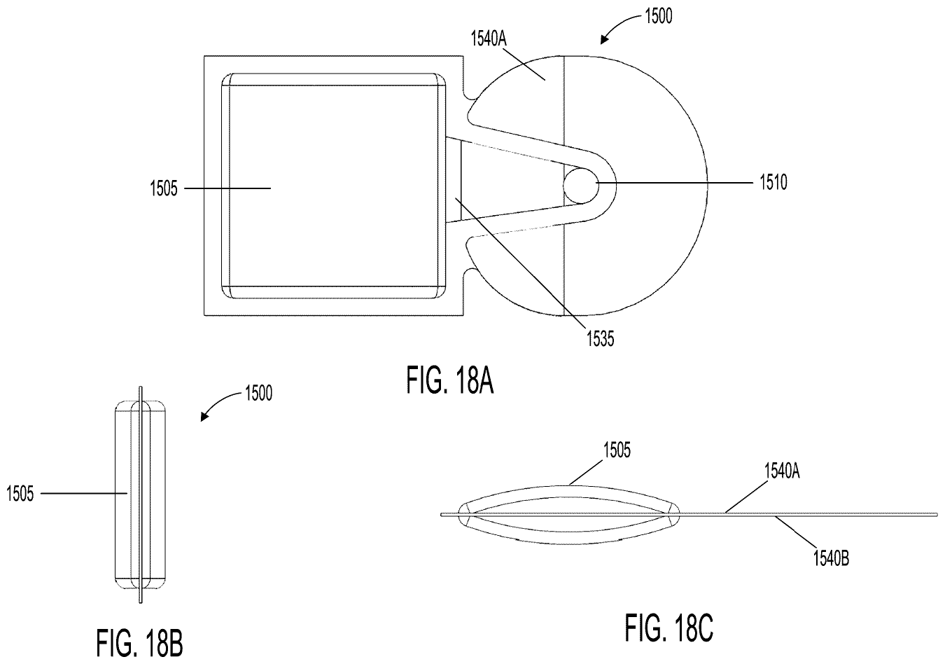

Referring now to FIGS. 18A, 18B, and 18C, illustrated are various additional views of the example sachet container 1500 shown in FIGS. 15A and 15B, in accordance with one or more implementations. FIG. 18A shows a top view of the sachet container 1500 container. As shown, the sachet container 1500 includes the fluid container 1505, the opening 1510, and a weakened portion 1535, which may rupture when an appropriate force is exerted on the fluid container 1505. When ruptured, fluid in the fluid container 1505 flows through a channel defined between the layers of material 1540A and 1540B (shown in FIG. 18C) and out of the opening 1510. FIG. 18B shows a front view of the sachet container 1500, and FIG. 18C shows a side view of the sachet container 1500. As shown in FIG. 18C, the sachet container 1500 can be a substantially flat container, and may be manufactured by coupling at least two layers 1540A and 1540B of material (e.g., a polymer material, etc.) together. In one implementation, the container has a volume of 10 mL and employs heat-welded edges.

Referring now to FIGS. 19A and 19B, illustrated are additional perspective views of the example sachet container 1500 shown in FIGS. 18A, 18B, and 18C, in accordance with one or more implementations. As shown in FIGS. 19A and 19B, the sachet container 1500 may be made of a flexible material, and may include a crease or seam that allows the circular portion on which the opening 1510 is formed to be folded over the fluid container 1505, with the opening 1510 facing away from the fluid container 1505. In some implementations, the folding process may be performed to rupture the weakened portion 1535, enabling the fluid to flow from the fluid container 1505 to the opening 1510. FIG. 19A shows a view of the sachet device 1500 with the opening 1510 exposed upward, and FIG. 19B shows a view of the sachet device 1500 with the opening 1510 (not shown) facing downward.

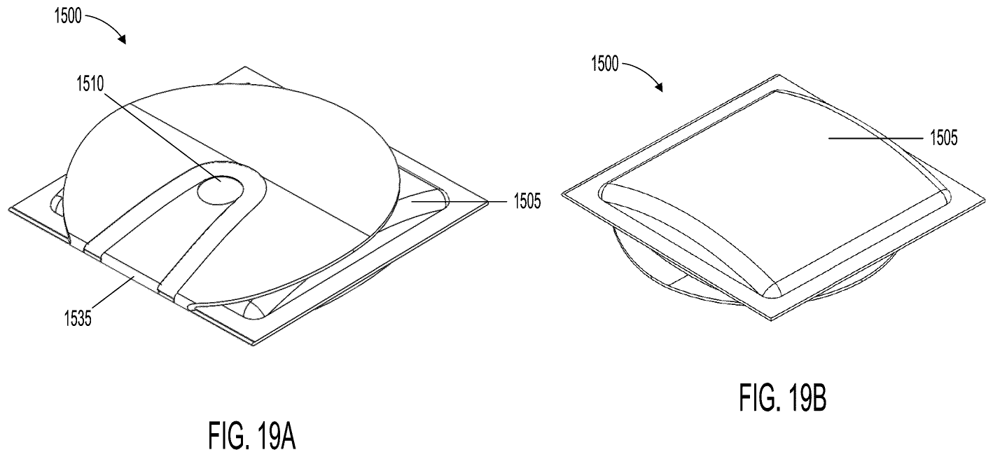

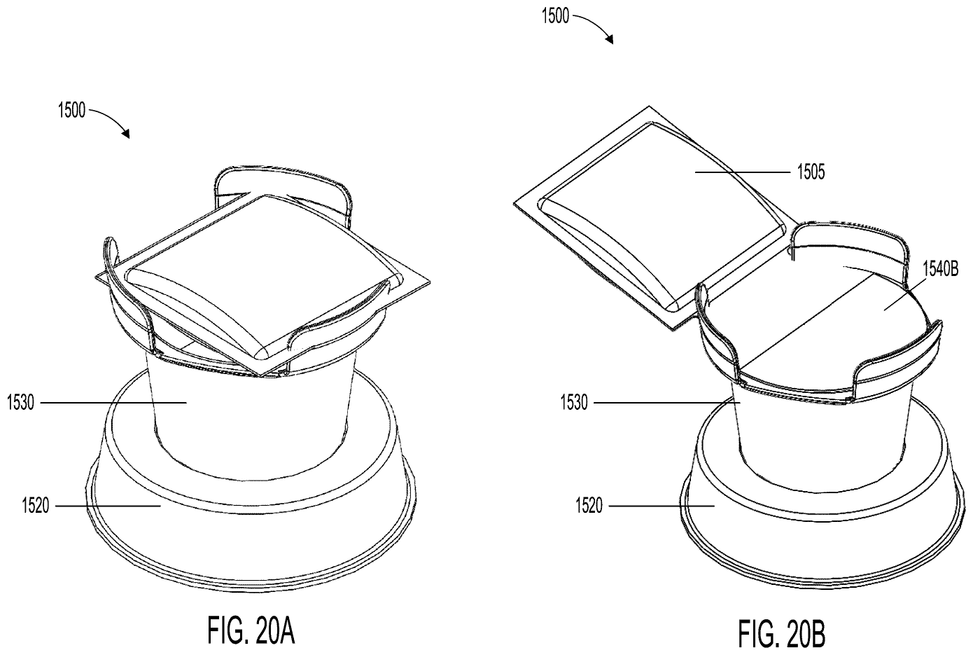

FIGS. 20A and 20B illustrate perspective views of the example sachet container 1500 and oral swab container 1530 with the base portion shown in FIG. 15B, in accordance with one or more implementations. As shown, the oral swab container 1530 may include a base portion 1520, which may stabilize the oral swab container 1530. Although not shown here, the oral swab container 1530 can contain an oral swab. Similar to the process described in connection with FIG. 16, the circular portion of the sachet container 1500 can be coupled to the top of the oral swab container 1530, with the opening 1510 (not shown) facing toward the inside of the oral swab container 1530. As shown in FIG. 20A, the sachet container 1500 can be coupled to the oral swab container 1530 in a folded position. Then, as shown in FIG. 20B, the fluid container 1505 can be unfolded while the circular portion of the sachet container 1500 remains coupled to the oral swab container 1530. The layer 1540B, which does not include the opening 1510, is facing upwards, while the layer 1540A (not shown) is pointed downwards into the oral swab container 1530.

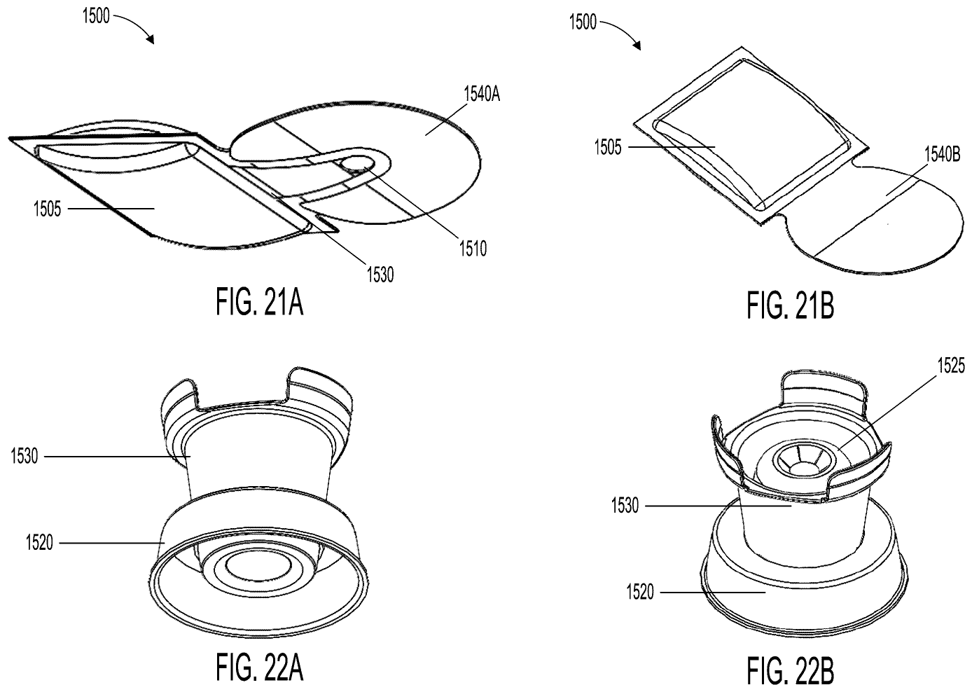

Referring now to FIGS. 21A and 21B, illustrated are additional perspective views of the example sachet container 1500 shown in FIGS. 18A-20B, in accordance with one or more implementations. These perspective views provide additional views of the material layers 1540A and 1540B, the opening 1510, and the fluid container 1505. The fluid container 1505 can be filled with any type of liquid or fluid. The sachet container 1500 may be manufactured from a disposable or recyclable material.

Referring now to FIGS. 22A and 22B, illustrated are perspective views of the example oral swab container 1530 with the base portion 1520 shown in FIG. 15B, in accordance with one or more implementations. As shown in FIG. 22A, the base portion 1520 may be circular with a single opening in its center. The central opening of the base portion 1520 can be slightly less than the average diameter of the oral swab container 1530, enabling the oral swab container 1530 to be inserted securely in the base portion 1520. As shown in FIG. 22B, the oral swab container 1530 can contain an oral swab 1525, which may be utilized in an oral care procedure after being saturated with an appropriate fluid (e.g., using a sachet container 1500, etc.). The oral swab 1525 may have a central opening, which may receive a brush head of an oral care device as described herein.

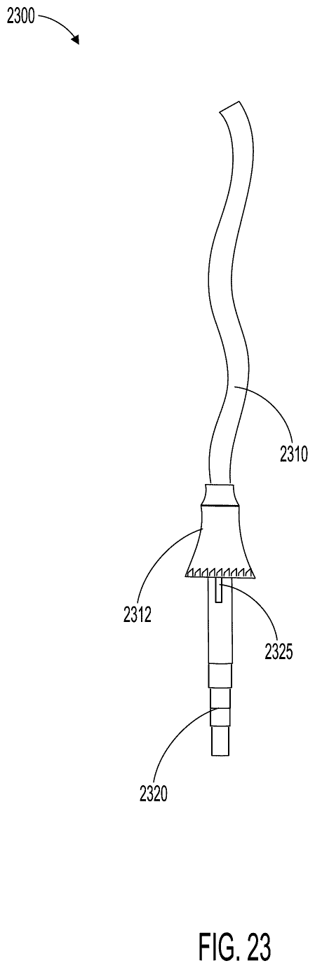

Referring now to FIG. 23, illustrated is a side view of an example Yankauer suction tip 2300 that is usable as a modular component in connection with the oral care devices described herein. For example, the Yankauer suction tip 2300 can be coupled with a grip portion of an oral care device, such as the grip portion 905 of FIG. 9 or the grip portion 1305 of FIG. 13. The Yankauer suction tip 2300 can include a connector 2320 that couples to a corresponding grip portion. The Yankauer suction tip 2300 can be a hollow tube that is in fluid communication with a suction pipe connector (e.g., the suction pipe connector 945, the suction pipe connector 1345, etc.). The Yankauer suction tip 2300 can include a grip 2312, which may cause the Yankauer suction tip 2300 to rotate about a longitudinal axis in response to a corresponding force (e.g., from a thumb of an operator of the oral care device). The Yankauer suction tip 2300 can include a hollow shaft 2310, and may include one or more suction apertures 2325. The hollow shaft 2310 may be manufactured from a rigid or a flexible material. The Yankauer suction tip 2300 may include a bulbous head (not pictured) that is designed to enable suction without damaging surrounding tissue. The tip 2300 may include additional suction apertures, for example, on the side.

The systems and devices described herein can be used in an oral care procedure, which can be implemented as part of an oral care policy. Aspects of an oral care policy can include assessing an oral cavity of a patient initially and daily. The oral care policy can specify that unconscious or intubated patients should be provided oral care every 2-4 hours, and as needed, in accordance with an oral care procedure. The policy can further specify that intubated patients should be assessed to determine the need for removal of oropharyngeal secretions every 8 hours, as well as prior to repositioning the tube or deflation of the cuff. One example of an oral care procedure is included below.

An oral care procedure can include setting up suction equipment, positioning the patient's head to the side or placing the patient's head in a semi-fowler's position, and providing suction, as needed, to intubated patients to remove oropharyngeal secretions that can migrate down the tube and settle on top of the cuff. The oral care procedure can include brushing the patient's teeth using the oral care device described herein, while applying small amounts of water and alcohol-free antiseptic oral rinse. The oral care procedure can specify that brushing should occur for approximately one to two minutes, while exerting gentle pressure and moving in short, horizontal or circular strokes. The oral care procedure can include gently brushing the patient's tongue. If brushing causes discomfort or bleeding, a suction swab can be used to clean the teeth and tongue. To do so, the swab can be placed perpendicular to the gum line, and used to apply gentle mechanical action for one to two minutes. The swab can then be turned in a clockwise rotation to remove mucous and debris. Finally, mouth moisturizer can be applied to the inside of the patient's mouth, and lip balm can be applied, if needed.

The oral swab containers described herein may sometimes be referred to as an oral care canister or a canister.

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations.

A functional hierarchy of an implementation of an apparatus as described herein can include a hollow shaft with a brushing means. The hollow shaft with the brushing means can be mounted on a tube with a forward-facing aperture and a back-facing aperture. The hollow shaft with the brushing means can be mounted on the tube with the apertures, and can be dipped into a mouthwash. The hollow shaft with the brushing means, when mounted on the tube, can be connected directly to a negative air pressure system for suction purposes. The hollow shaft with the brushing means, when mounted on the tube with the apertures, can be connected to a handgrip. The handgrip, with the hollow shaft and tube connected thereto, can be connected to the negative air pressure system. In some implementations, the handgrip can contain liquids.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation may be included in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations of the items listed thereafter. In one implementation, the systems and methods described herein comprise one, each combination of more than one, or all of the described elements, acts, or components.

As used herein, the terms “about” and “substantially” will be understood by persons of ordinary skill in the art and will vary to some extent depending upon the context in which they are used. If there are uses of the term which are not clear to persons of ordinary skill in the art given the context in which it is used, “about” will mean up to plus or minus 10% of the particular term.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

The indefinite articles “a” and “an,” as used herein in the specification and in the claims, unless clearly indicated to the contrary, should be understood to mean “at least one.”

References to “or” may be construed as inclusive so that any terms described using “or” may indicate any of a single, more than one, and all the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description, or any claim are followed by reference signs, the reference signs have been included to increase the intelligibility of the drawings, detailed description, and claims. Accordingly, neither the reference signs nor their absence has any limiting effect on the scope of any claim elements.

The systems and methods described herein may be embodied in other specific forms without departing from the characteristics thereof. The foregoing implementations are illustrative rather than limiting of the described systems and methods. The scope of the systems and methods described herein is thus indicated by the appended claims, rather than the foregoing description, and changes that come within the meaning and range of equivalency of the claims are embraced therein.

What is claimed is:

1. An oral care device, comprising:
a hollow shaft having a first end comprising a first suction aperture, and a second end comprising a second suction aperture, the second end of the hollow shaft configured to insert into a hand grip;
a sleeve surrounding a portion of the hollow shaft, the sleeve configured to slide along a longitudinal axis and configured to conceal at least a portion of the first suction aperture or the second suction aperture; and
a cleaning portion coupled to a portion of the sleeve proximate to the first end of the hollow shaft.

2. The oral care device of claim 1, further comprising a liquid container in fluid communication with the hollow shaft.

3. The oral care device of claim 2, wherein the liquid container is disposed within the hand grip that receives the second end of the hollow shaft; and
wherein the hand grip further comprises a channel fluidly coupling the liquid container to the hollow shaft.

4. The oral care device of claim 1, wherein the hollow shaft further comprises a first stop at the first end of the hollow shaft and a second stop at the second end of the hollow shaft, wherein the first stop and the second stop prevent the sleeve from sliding beyond the first end and the second end, respectively.

5. The oral care device of claim 1, further comprising the hand grip, and wherein the hand grip further comprises a fitting configured to attach to a suction pipe.

6. The oral care device of claim 1, wherein the sleeve further comprises an attachment portion, and the cleaning portion is coupled to the sleeve via the attachment portion.

7. The oral care device of claim 1, wherein the cleaning portion includes a brush head comprising a plurality of bristles extending outward.

8. The oral care device of claim 7, wherein the brush head further comprises one or more foam portions positioned adjacent to the plurality of bristles.

9. The oral care device of claim 1, wherein the cleaning portion is configured to couple to an external swab.

10. The oral care device of claim 1, wherein the cleaning portion is semipermeable and allows selective passage of liquids through the cleaning portion and into the first suction aperture.

11. The oral care device of claim 1, wherein the cleaning portion comprises a brush head configured to receive a spreading head.

12. The oral care device of claim 1, wherein the sleeve is rotatable about the longitudinal axis.

13. The oral care device of claim 1, wherein the sleeve is configured to be rotated about the longitudinal axis by a user's thumb and/or finger.

14. The oral care device of claim 1, further comprising a container proximate the second end and comprising liquid, the container configured to direct liquid toward the first end when force is exerted on the container.

15. The oral care device of claim 14, further comprising a passage configured to receive the liquid from the container and direct the liquid to the cleaning portion.

16. A brush head, comprising:
a receiving cavity defined by one or more walls, the receiving cavity configured to receive a cleaning end of an oral care device;
a first end of the one or more walls comprising a plurality of bristles projecting outward from a central axis of the brush head; and
a central portion having a liquid channel, and a perforator projecting outward from the central axis of the brush head.

17. The brush head of claim 16, further comprising a liquid reservoir coupled to the central portion of the brush head.

18. The brush head of claim 17, wherein the liquid reservoir comprises two sections connected by a hinge; and
wherein the liquid reservoir is mounted on the brush head such that the liquid reservoir surrounds the central portion and is punctured by the perforator.

19. The brush head of claim 18, wherein the liquid reservoir further comprises a connector configured to couple the two sections of the liquid reservoir with one another responsive to the liquid reservoir being mounted to the central portion of the brush head.

20. The brush head of claim 17, wherein the liquid reservoir is surrounded by a foam layer.

21. The brush head of claim 16, wherein the liquid channel of the central portion is configured to transmit fluid to a base of one or more of the plurality of bristles.

22. The brush head of claim 16, wherein the receiving cavity further comprises a snap-fit connector configured to couple to the cleaning end of the oral care device.

23. A container for a swab, comprising:
one or more walls defining an opening of the container;
a solution disposed within the container;
an oral swab positioned at least partly in the solution such that an opening of the oral swab may be exposed via the opening of the container, the opening of the oral swab configured to receive a cleaning portion of an oral care device; and
a removable lid that seals the opening of the container.

24. The container of claim 23, wherein the oral swab further comprises a snap-fit connector configured to couple the oral swab to the cleaning portion of the oral care device.

25. The container of claim 24, wherein the oral swab is removable from the container responsive to coupling to the cleaning portion of the oral care device.

26. An oral care device, comprising:
a hollow shaft having a first end comprising a first suction aperture, and a second end comprising a second suction aperture, the second end of the hollow shaft configured to insert into a hand grip;
a sleeve surrounding a portion of the hollow shaft, the sleeve configured to slide along a longitudinal axis and conceal at least a portion of the first suction aperture or the second suction aperture;
a cleaning portion coupled to a portion of the sleeve at the first end of the hollow shaft; and
a brush head, comprising:
a receiving cavity defined by one or more walls that receives the cleaning portion;
a first end of the one or more walls comprising a plurality of bristles projecting outward from a central axis of the brush head; and
a central portion having a liquid channel, and a perforator projecting outward from the central axis of the brush head.

27. A method of treatment of a patient in need of oral care, comprising cleaning the oral cavity of the patient's mouth using the oral care device of claim 1.

28. A method of treatment of a patient in need of oral care, comprising cleaning the oral cavity of the patient's mouth using the oral care device of claim 26.

29. An assembly for preparing a swab, comprising:
a cannister comprising one or more walls defining an opening of the cannister;
an oral swab positioned in the cannister such that an opening of the oral swab may be exposed via the opening of the cannister, the opening of the oral swab configured to receive a cleaning portion of an oral care device;
a removable lid that seals the opening of the cannister; and
a packet configured to be placed proximate the opening of the cannister when the lid is removed, the packet comprising a liquid, the packet configured to release the liquid into the oral swab when force is applied to the packet.

30. The assembly of claim 29, wherein the packet comprises a sachet.

31. The assembly of claim 29, wherein the packet comprises a sachet with a weakened portion configured to release the liquid when force is applied to the sachet.

32. The assembly of claim 29, wherein the packet comprises a sachet with a peel-off portion.

33. The assembly of claim 29, wherein the packet comprises a container with a portion configured to be punctured.
